(19) United States
(12) Patent Application Publication
(10) Pub. No.: US 2025/0106272 A1
(43) Pub. Date: Mar. 27, 2025

(54) Community Playback Devices

(71) Applicant: Sonos, Inc., Goleta, CA (US)

(72) Inventors: Adam Kumpf, Delaware, OH (US); Roger Jackson, Lake Forest Park, WA (US)

(21) Appl. No.: 18/897,682

(22) Filed: Sep. 26, 2024

Related U.S. Application Data
(60) Provisional application No. 63/585,771, filed on Sep. 27, 2023.

(51) Int. Cl. H04L 65/613; H04L 65/752

(52) U.S. Cl. CPC H04L 65/613; H04L 65/752

(57) ABSTRACT

An example playback device is configured to (i) transmit an indication that the playback device is available for connection, (ii) receive, from a first controller device, a first request to connect to the playback device, (iii) based on the first request, connect to the first controller device, (iv) while connected to first controller device: (a) continue to transmit the indication that the playback device is available for connection, (b) receive, from a second controller device, a second request to connect to the playback device, and (c) based on the second request, connect to the second controller device, and (v) while connected to the first and second controller device: (a) continue to transmit the indication that the playback device is available for connection, (b) receive, from the first controller device, an indication of media content for playback, (c) retrieve the indicated media content, and (d) play back the indicated media content.

### CROSS-REFERENCE TO RELATED APPLICATIONS

This application claims priority to U.S. Provisional Application No. 63/585,771, filed Sep. 27, 2023, and titled “Community Playback Devices,” the contents of which are incorporated herein by reference in their entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g..., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

Given the ever-growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of an example playback device.

FIG. 1D is a block diagram of an example playback device.

FIG. 1E is a block diagram of an example playback device.

FIG. 1F is a block diagram of an example network microphone device.

FIG. 1G is a block diagram of an example playback device.

FIG. 1H is a partially schematic diagram of an example control device.

FIG. 1I is a schematic diagram of example user interfaces of the example control device of FIG. 1H.

FIGS. 1J through 1M are schematic diagrams of example media playback system zones.

FIG. 1N is a schematic diagram of example media playback system areas.

FIG. 2 is a diagram of an example headset assembly for an example playback device.

FIG. 3 is an isometric diagram of an example playback device housing.

FIG. 4 is a block diagram of an example playback device.

FIG. 5 is a flowchart that illustrates operations that may be carried out by a playback device to provide a community media playback experience.

FIG. 6 is a diagram of a controller device presenting a visualization of a media playback system controller application for finding community spaces.

FIG. 7 is a diagram of a controller device presenting a visualization of a media playback system controller application for joining a community space.

FIG. 8 is a diagram of a controller device presenting an example visualization of a media playback system controller application that may be presented by a controller device that has connected to a playback device.

FIG. 9 is a flowchart that illustrates operations that may be carried out by a playback device to manage a playback queue.

FIG. 10 depicts a playback queue that may be managed by a playback device.

FIG. 11 is a flowchart that illustrates operations that may be carried out by a playback device to manage a playback queue.

FIG. 12 depicts a playback queue that may be managed by a playback device.

FIG. 13 depicts a playback queue that may be managed by a playback device.

### DETAILED DESCRIPTION

### I. Overview

Over the years, Sonos, Inc. (“Sonos”) has been an innovator in creating media playback system (MPS) solutions that are capable of delivering personalized listening experiences to customers. These solutions include (i) a suite of various playback devices that Sonos has created to meet any of various situations, as well as (ii) a media playback system controller application (“MPS controller application”) that enables users to personalize their media playback systems according to their taste. An owner of a Sonos playback device may create an account for the MPS, which may be curated to the user's preferences. Via the MPS controller application, a user may quickly navigate to their favorite playlists, or to a “discover” feature of the MPS controller application that may suggest media content that the user may be interested in, for example, based on historical listening information of the user. The MPS controller application may include various other features as well, including (i) calibration control features, (ii) playback device grouping control features, and (iii) playback device setup control features, among various others.

Individuals who do not own a Sonos speaker may nonetheless be interested in participating in the Sonos experience. However, current options for such individuals are limited. As one option, an individual without a Sonos speaker may interact with a point-of-sale display that provides limited functionality for controlling a Sonos speaker, as discussed in U.S. Pat. No. 10,296,884, entitled “Personalized Media Playback at a Discovered Point-of-Sale Display,” which is herein incorporated by reference in its entirety. As another option, an individual may use another person's Sonos media playback system, for example, as a guest. Some examples involving guest access to another user's media playback system are described in U.S. Pat. No. 9,374,607, entitled “Media Playback System with Guest Access” and U.S. Pat. No. 9,977,561, entitled “Systems, Methods, Apparatus, and Articles of Manufacture to Provide Guest Access” both of which are herein incorporated by reference in their entirety. As another option, an individual may enter a business that owns a Sonos media playback system. In each of these cases, the individual may have some level of access to controlling the Sonos media playback system, but such access may be limited. Further, the individual's access may be dependent on the availability and willingness of the owners of the Sonos media playback systems to allow the individual to use their media playback systems. What is needed is a general-access playback device (e.g., located in a public space or the like) that anyone can access and control to enjoy the Sonos media playback experience.

To address these and other issues, new techniques are discussed below that facilitate generalized access to one or more openly-available playback devices, which may provide for a community media playback experience. To facilitate a community media playback experience of this kind, a playback device may be positioned in a community space, such as a recreation center. The “community” playback device may determine a context of the community space, and play back media content that may be related to the determined context. Further, the community playback device may, as described in greater detail herein, establish connections to one or more controller devices in the community space that are installed with the MPS controller application, without any other account-based or network-based access restrictions. Once connected, the community playback device may receive indications of media content from the one or more controller devices and, among other things, manage a playback queue to include the media content indicated by the one or more controller devices in the community space. In this way, any individual with access to a device (e.g., a smartphone, a shared public controller in the community space, etc.) that is capable of acting as a control device can access the community playback device and participate in a community playback experience. Furthermore, such a community playback device could also include additional features that may provide a community media playback experience that is adapted for the community (e.g., volume control based on time/day/schedule, limiting content with adult/explicit lyrics during kid-friendly sessions, tonal filtering to reduce heavy bass to neighbors, etc.) or that may provide for the durability of the community playback device (e.g., designed to be physically secured, rugged, waterproof, etc.).

In some embodiments, a playback device is provided including at least one processor, a first wireless communication interface for communicating over a wide area network (WAN), a second wireless communication interface for communicating with at least one of controller devices or playback devices, non-transitory computer-readable medium, and program instructions stored on the non-transitory computer-readable medium that are executable by the at least one processor such that the playback device is configured to: (i) transmit, via the second wireless communication interface, an indication that the playback device is available for connection, (ii) receive, via the second wireless communication interface, from a first controller device that is installed with an application for controlling the playback device, a first request to connect to the playback device, (iii) based on the first request, connect to the first controller device via the second wireless communication interface, (iv) while connected to first controller device: (a) continue to transmit, via the second wireless communication interface, the indication that the playback device is available for connection, (b) receive, via the second wireless communication interface, from a second controller device that is installed with the application for controlling the playback device, a second request to connect to the playback device, and (c) based on the second request, connect to the second controller device via the second wireless communication interface, and (v) while connected to both the first controller device and the second controller device: (a) continue to transmit, via the second wireless communication interface, the indication that the playback device is available for connection, (b) receive, via the second wireless communication interface, from the first controller device, an indication of media content for playback, (c) retrieve, via the first wireless communication interface over the WAN, the indicated media content, and (d) play back the indicated media content.

In another aspect, a non-transitory computer-readable medium in provided. The non-transitory computer-readable medium is provisioned with program instructions that, when executed by at least one processor, cause a playback device including a first wireless communication interface for communicating over a wide area network (WAN) and a second wireless communication interface for communicating with at least one of controller devices or playback devices to: (i) transmit, via the second wireless communication interface, an indication that the playback device is available for connection, (ii) receive, via the second wireless communication interface, from a first controller device that is installed with an application for controlling the playback device, a first request to connect to the playback device, (iii) based on the first request, connect to the first controller device via the second wireless communication interface, (iv) while connected to first controller device: (a) continue to transmit, via the second wireless communication interface, the indication that the playback device is available for connection, (b) receive, via the second wireless communication interface, from a second controller device that is installed with the application for controlling the playback device, a second request to connect to the playback device, and (c) based on the second request, connect to the second controller device via the second wireless communication interface, and (v) while connected to both the first controller device and the second controller device: (a) continue to transmit, via the second wireless communication interface, the indication that the playback device is available for connection, (b) receive, via the second wireless communication interface, from the first controller device, an indication of media content for playback, (c) retrieve, via the first wireless communication interface over the WAN, the indicated media content, and (d) play back the indicated media content.

In yet another aspect, a method carried out by a playback device including a first wireless communication interface for communicating over a wide area network (WAN) and a second wireless communication interface for communicating with at least one of controller devices or playback devices includes (i) transmitting, via the second wireless communication interface, an indication that the playback device is available for connection, (ii) receiving, via the second wireless communication interface, from a first controller device that is installed with an application for controlling the playback device, a first request to connect to the playback device, (iii) based on the first request, connecting to the first controller device via the second wireless communication interface, (iv) while connected to first controller device: (a) continuing to transmit, via the second wireless communication interface, the indication that the playback device is available for connection, (b) receiving, via the second wireless communication interface, from a second controller device that is installed with the application for controlling the playback device, a second request to connect to the playback device, and (c) based on the second request, connecting to the second controller device via the second wireless communication interface, and (v) while connected to both the first controller device and the second controller device: (a) continuing to transmit, via the second wireless communication interface, the indication that the playback device is available for connection, (b) receiving, via the second wireless communication interface, from the first controller device, an indication of media content for playback, (c) retrieving, via the first wireless communication interface over the WAN, the indicated media content, and (d) playing back the indicated media content.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

Moreover, some functions are described herein as being performed “based on” or “in response to” another element or function. “Based on” should be understood that one element or function is related to another function or element. “In response to” should be understood that one element or function is a necessary result of another function or element. For the sake of brevity, functions are generally described as being based on another function when a functional link exists; however, such disclosure should be understood as disclosing either type of functional relationship.

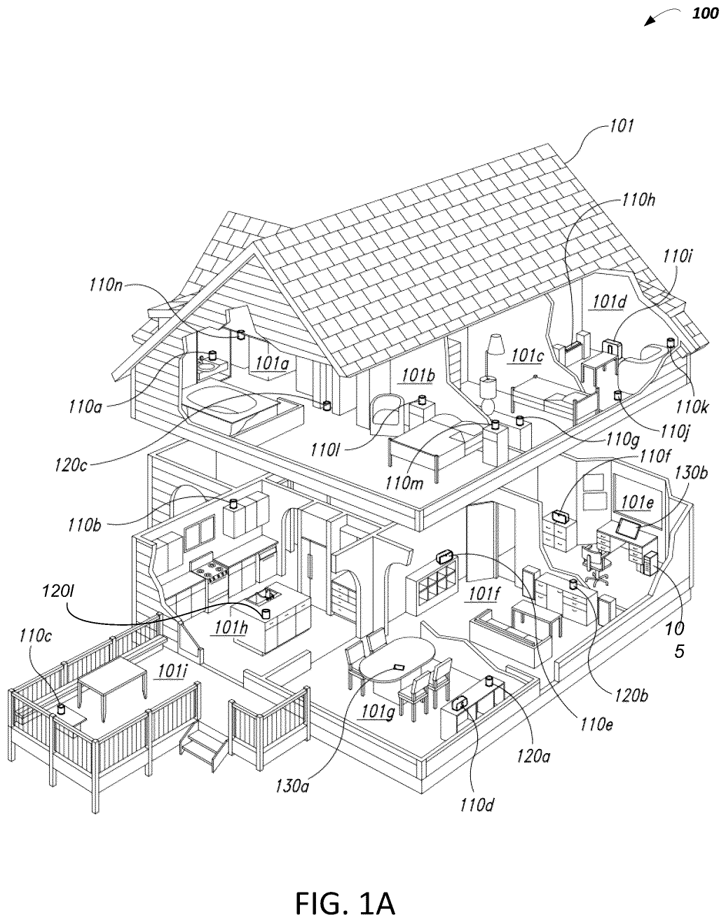

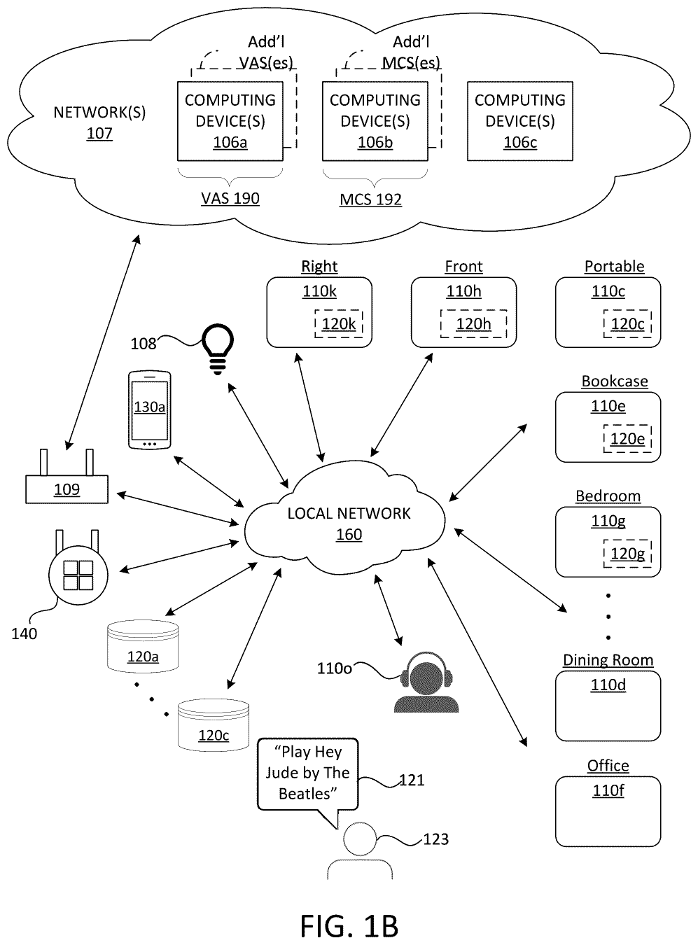

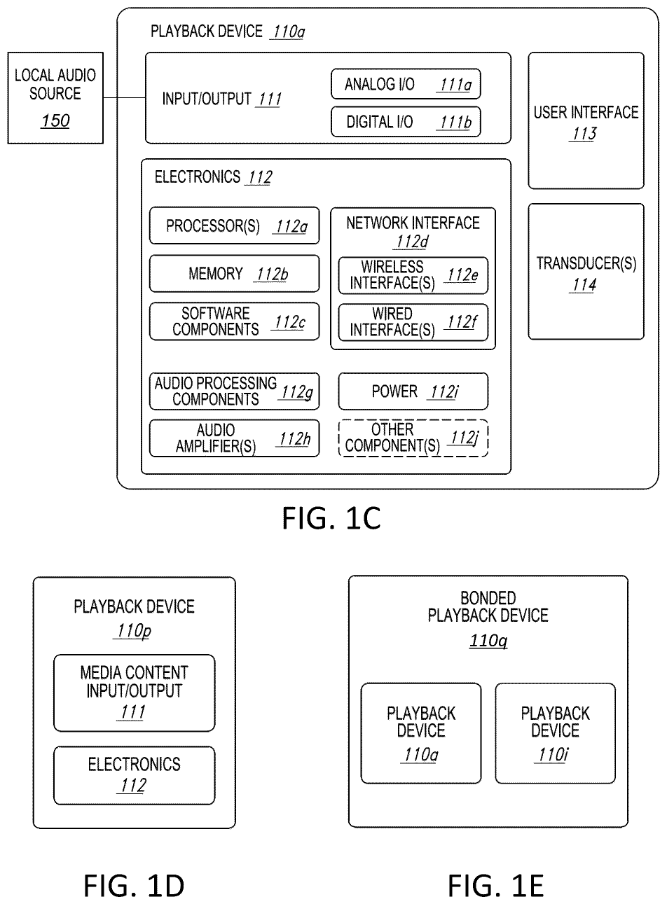

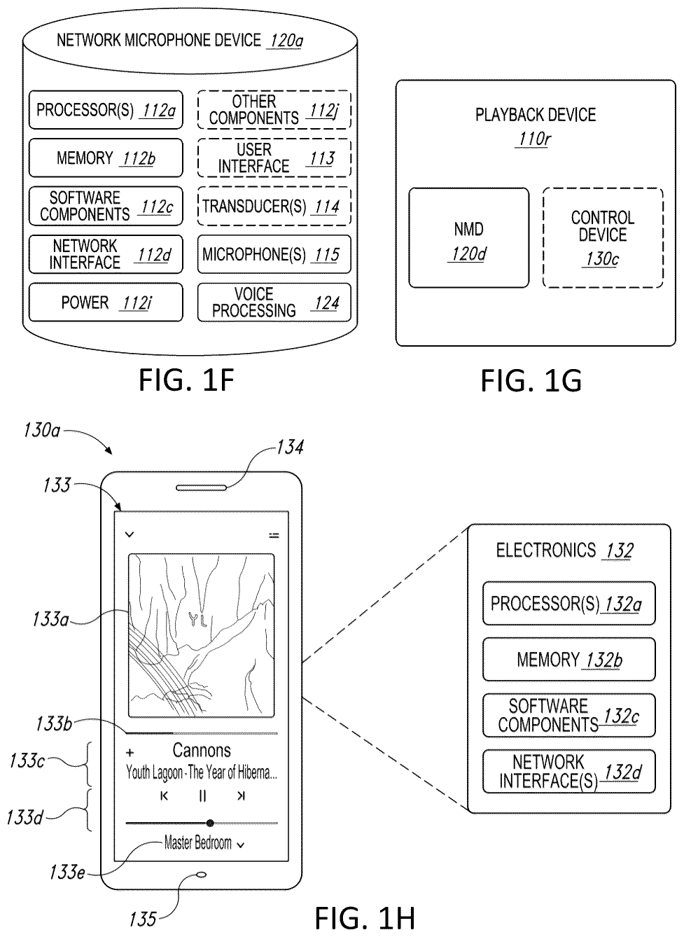

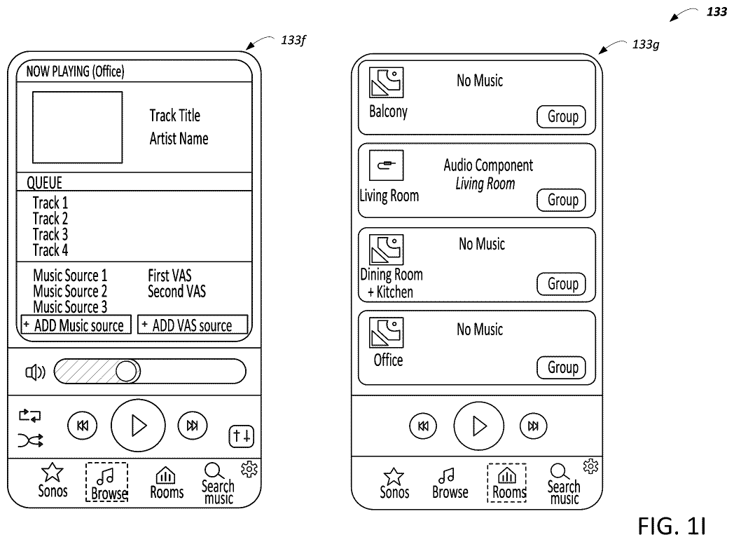

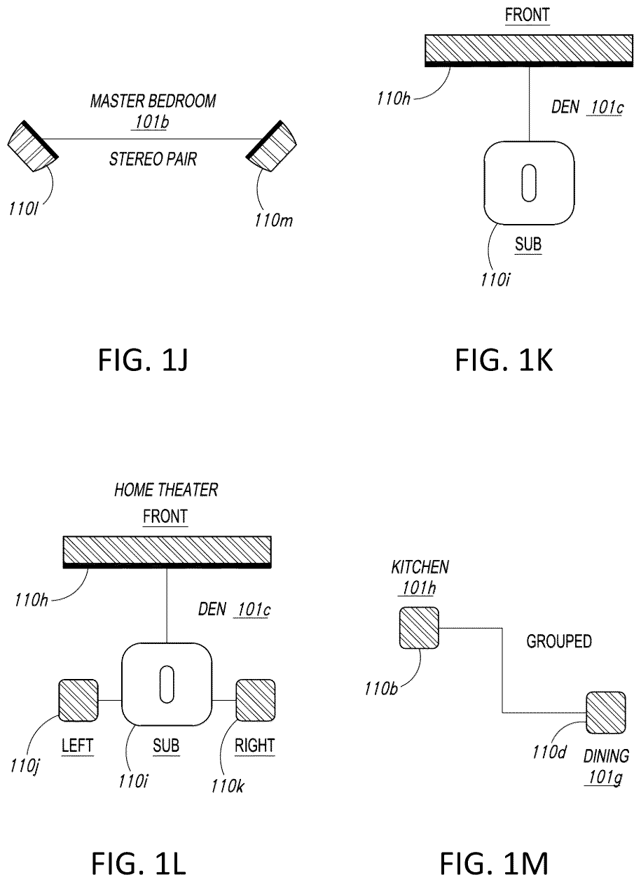

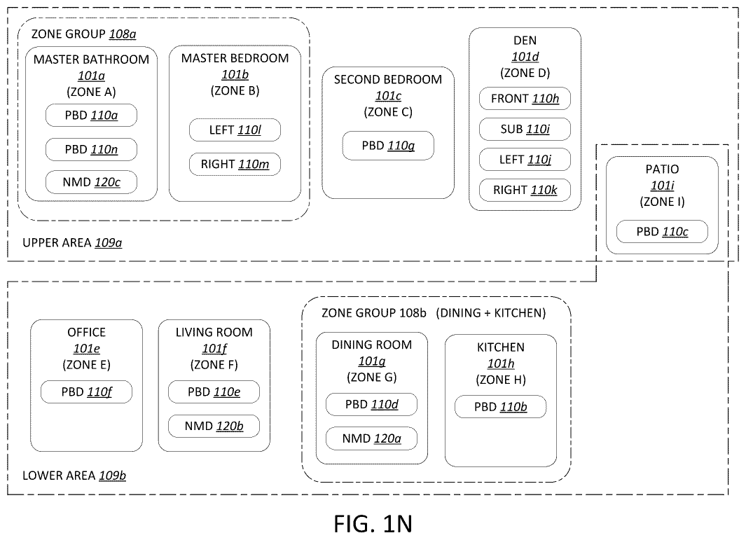

In the figures, identical reference numbers identify generally similar, and/or identical, elements. To facilitate the discussion of any particular element, the most significant digit or digits of a reference number refers to the figure in which that element is first introduced. For example, element 110a is first introduced and discussed with reference to FIG. 1A. Many of the details, dimensions, angles and other features shown in the figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

### a. Suitable Media Playback System

FIGS. 1A and 1B illustrate an example configuration of a media playback system (“MPS”) 100 in which one or more embodiments disclosed herein may be implemented. Referring first to FIG. 1A, a partial cutaway view of MPS 100 distributed in an environment 101 (e.g., a house) is shown. The MPS 100 as shown is associated with an example home environment having a plurality of rooms and spaces. The MPS 100 comprises one or more playback devices 110 (identified individually as playback devices 110a-o), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes media content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the MPS 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the MPS 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the MPS 100 is configured to play back audio from a first playback device (e.g., the playback device 110a) in synchrony with a second playback device (e.g., the playback device 110b). Interactions between the playback devices 110, NMDs 120, and/or control devices 130 of the MPS 100 configured in accordance with the various embodiments of the disclosure are described in greater detail below with respect to FIGS. 1B-1N.

In the illustrated embodiment of FIG. 1A, the environment 101 comprises a household having several rooms, spaces, and/or playback zones, including (clockwise from upper left) a Master Bathroom 101a, a Master Bedroom 101b, a Second Bedroom 101c, a Family Room or Den 101d, an Office 101c, a Living Room 101f, a Dining Room 101g, a Kitchen 101h, and an outdoor Patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The MPS 100 can comprise one or more playback zones, some of which may correspond to the rooms in the environment 101. The MPS 100 can be established with one or more playback zones, after which additional zones may be added and/or removed to form, for example, the configuration shown in FIG. 1A. Each zone may be given a name according to a different room or space such as the Office 101e, Master Bathroom 101a, Master Bedroom 101b, the Second Bedroom 101c, Kitchen 101h, Dining Room 101g, Living Room 101f, and/or the Patio 101i. In some aspects, a single playback zone may include multiple rooms or spaces. In certain aspects, a single room or space may include multiple playback zones.

In the illustrated embodiment of FIG. 1A, the Master Bathroom 101a, the Second Bedroom 101c, the Office 101e, the Living Room 101f, the Dining Room 101g, the Kitchen 101h, and the outdoor Patio 101i each include one playback device 110, and the Master Bedroom 101b and the Den 101d include a plurality of playback devices 110. In the Master Bedroom 101b, the playback devices 110l and 110m may be configured, for example, to play back media content in synchrony as individual ones of playback devices 110, as a bonded playback zone, as a consolidated playback device, and/or any combination thereof. Similarly, in the Den 101d, the playback devices 110h-j can be configured, for instance, to play back media content in synchrony as individual ones of playback devices 110, as one or more bonded playback devices, and/or as one or more consolidated playback devices.

Referring to FIG. 1B, the home environment may include additional and/or other control devices, including local network devices, such as one or more smart illumination devices 108 (FIG. 1B), a smart thermostat 140 (FIG. 1B), and a local control device 105 (FIG. 1A). Numerous other examples of local network devices (not shown) are also possible, such as doorbells, cameras, smoke alarms, televisions, gaming consoles, garage door openers, etc. In embodiments described below, one or more of the various playback devices 110 may be configured as portable playback devices, while others may be configured as stationary playback devices. For example, the headphones 110o (FIG. 1B) are a portable playback device, while the playback device 110e on the bookcase may be a stationary device. As another example, the playback device 110c on the Patio 101i may be a battery-powered device, which may allow it to be transported to various areas within the environment 101, and outside of the environment 101, when it is not plugged in to a wall outlet or the like.

With reference still to FIG. 1B, the various playback, network microphone, and controller devices and/or other network devices of the MPS 100 may be coupled to one another via point-to-point connections and/or over other connections, which may be wired and/or wireless, via a local network 160 that may include a network router 109. For example, the playback device 110j in the Den 101d (FIG. 1A), which may be designated as the “Left” device, may have a point-to-point connection with the playback device 110k, which is also in the Den 101d and may be designated as the “Right” device. In a related embodiment, the Left playback device 110j may communicate with other network devices, such as the playback device 110h, which may be designated as the “Front” device, via a point-to-point connection and/or other connections via the local network 160.

The local network 160 may be, for example, a network that interconnects one or more devices within a limited area (e.g., a residence, an office building, a car, an individual's workspace, etc.). The local network 160 may include, for example, one or more local area networks (LANs) such as a wireless local area network (WLAN) (e.g., a WiFi network, a Z-Wave network, etc.) and/or one or more personal area networks (PANs) (e.g., a BLUETOOTH network, a wireless USB network, a ZigBee network, an IRDA network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.12, 802.11ac, 802.11ac, 802.11ad, 802.11af, 802.11ah, 802.11ai, 802.11aj, 802.1laq, 802.11ax, 802.1lay, 802.15, etc. transmitted at 2.4 Gigahertz (GHz), 5 GHZ, 6 GHZ, and/or another suitable frequency.

The MPS 100 is configured to receive media content from the local network 160. The received media content can comprise, for example, a Uniform Resource Identifier (URI) and/or a Uniform Resource Locator (URL). For instance, in some examples, the MPS 100 can stream, download, or otherwise obtain data from a URI or a URL corresponding to the received media content.

As further shown in FIG. 1B, the MPS 100 may be coupled to one or more remote control devices 106 via a wide area network (“WAN”) 107. In some embodiments, each remote control device 106 may take the form of one or more cloud servers. The remote control devices 106 may be configured to interact with control devices in the environment 101 in various ways. For example, the remote control devices 106 may be configured to facilitate streaming and/or controlling playback of media content, such as audio, in the environment 101 (FIG. 1A).

In some implementations, the various playback devices 110, NMDs 120, and/or control devices 130 may be communicatively coupled to at least one remote control device associated with a voice assistant service (“VAS”) and/or at least one remote control device associated with a media content service (“MCS”). For instance, in the illustrated example of FIG. 1B, remote control devices 106a are associated with a VAS 190 and remote control devices 106b are associated with an MCS 192. Although only a single VAS 190 and a single MCS 192 are shown in the example of FIG. 1B for purposes of clarity, the MPS 100 may be coupled to any number of different VASes and/or MCSes. In some embodiments, the various playback devices 110, NMDs 120, and/or control devices 130 may transmit data associated with a received voice input to a VAS configured to (i) process the received voice input data and (ii) transmit a corresponding command to the MPS 100. In some aspects, for example, the control devices 106a may comprise one or more modules and/or servers of a VAS. In some implementations, VASes may be operated by one or more of SONOS®, AMAZON®, GOOGLE® APPLE®, MICROSOFT®, NUANCE®, or other voice assistant providers. In some implementations, MCSes may be operated by one or more of SPOTIFY®, PANDORA®, AMAZON MUSIC®, YOUTUBE MUSIC, APPLE MUSIC®, GOOGLE PLAY®, or other media content services.

In some embodiments, the local network 160 comprises a dedicated communication network that the MPS 100 uses to transmit messages between individual devices and/or to transmit media content to and from MCSes. In certain embodiments, the local network 160 is configured to be accessible only to devices in the MPS 100, thereby reducing interference and competition with other household devices. In other embodiments, however, the local network 160 comprises an existing household communication network (e.g., a household WiFi network). In some embodiments, the MPS 100 is implemented without the local network 160, and the various devices comprising the MPS 100 can communicate with each other, for example, via one or more direct connections, PANs, telecommunication networks (e.g., an LTE network or a 5G network, etc.), and/or other suitable communication links.

In some embodiments, media content sources may be regularly added and/or removed from the MPS 100. In some embodiments, for example, the MPS 100 performs an indexing of media items when one or more media content sources are updated, added to, and/or removed from the MPS 100. The MPS 100 can scan identifiable media items in some or all folders and/or directories accessible to the various playback devices and generate or update a media content database comprising metadata (e.g., title, artist, album, track length) and other associated information (e.g., URIs, URLs) for each identifiable media item found. In some embodiments, for example, the media content database is stored on one or more of the various playback devices, network microphone devices, and/or control devices of MPS 100.

As further shown in FIG. 1B, the remote control devices 106 further include remote control device(s) 106c configured to perform certain operations, such as remotely facilitating media playback functions, managing device and system status information, directing communications between the devices of the MPS 100 and one or multiple VASes and/or MCSes, among other operations. In one example, the remote control devices 106c provide cloud servers for one or more SONOS Wireless HiFi Systems.

In various implementations, one or more of the playback devices 110 may take the form of or include an on-board (e.g., integrated) network microphone device configured to detect sound, including voice utterances from a user. For example, the playback devices 110c-110h, and 110k include or are otherwise equipped with corresponding NMDs 120c-120h, and 120k, respectively. A playback device that includes or is equipped with an NMD may be referred to herein interchangeably as a playback device or an NMD unless indicated otherwise in the description. In some cases, one or more of the NMDs 120 may be a stand-alone device. For example, the NMD 1201 (FIG. 1A) may be a stand-alone device. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 110 and 120 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 110e because it is physically situated on a bookcase. Similarly, the NMD 120l may be assigned the named “Island” because it is physically situated on an island countertop in the Kitchen 101h (FIG. 1A). Some playback devices may be assigned names according to a zone or room, such as the playback devices 110g, 110d, and 110f, which are named “Bedroom,” “Dining Room,” and “Office,” respectively. Further, certain playback devices may have functionally descriptive names. For example, the playback devices 110k and 110h are assigned the names “Right” and “Front,” respectively, because these two devices are configured to provide specific audio channels during media playback in the zone of the Den 101d (FIG. 1A). The playback device 110c in the Patio 101i may be named “Portable” because it is battery-powered and/or readily transportable to different areas of the environment 101. Other naming conventions are possible.

As discussed above, an NMD may detect and process sound from its environment, including audio output played by itself, played by other devices in the environment 101, and/or sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word (also referred to herein as an activation word) associated with a particular VAS.

In the illustrated example of FIG. 1B, the NMDs 120 are configured to interact with the VAS 190 over the local network 160 and/or the router 109. Interactions with the VAS 190 may be initiated, for example, when an NMD identifies in the detected sound a potential wake word. The identification causes a wake-word event, which in tum causes the NMD to begin transmitting detected-sound data to the VAS 190. In some implementations, the various local network devices 105, 110, 120, and 130 (FIG. 1A) and/or remote control devices 106c of the MPS 100 may exchange various feedback, information, instructions, and/or related data with the remote control devices associated with the selected VAS. Such exchanges may be related to or independent of transmitted messages containing voice inputs. In some embodiments, the remote control device(s) and the MPS 100 may exchange data via communication paths as described herein and/or using a metadata exchange channel as described in U.S. Pat. No. 10,499,146, issued Nov. 13, 2019 and titled “Voice Control of a Media Playback System,” which is herein incorporated by reference in its entirety.

Upon receiving the stream of sound data, the VAS 190 may determine if there is voice input in the streamed data from the NMD, and if so the VAS 190 may also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude” performed by The Beatles. After these determinations, the VAS 190 may transmit a command to a particular MCS 192 to retrieve content (i.e., the song “Hey Jude” by The Beatles), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 110e in the environment 101 (FIG. 1A) is in relatively close proximity to the NMD-equipped Living Room playback device 120b, and both devices 110e and 120b may at least sometimes detect the same sound. In such cases, this may require arbitration as to which device is ultimately responsible for providing detected-sound data to the remote VAS. Examples of arbitrating between NMDs may be found, for example, in previously referenced U.S. Pat. No. 10,499,146.

In certain implementations, an NMD may be assigned to, or otherwise associated with, a designated or default playback device that may not include an NMD. For example, the Island NMD 120l in the Kitchen 101h (FIG. 1A) may be assigned to the Dining Room playback device 110d, which is in relatively close proximity to the Island NMD 120l. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Pat. No. 10,499,146.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback devices 110, network microphone devices 120, and/or control devices 130. For example, the technologies herein may be utilized within an environment having a single playback device 110 and/or a single NMD 120. In some examples of such cases, the local network 160 (FIG. 1B) may be eliminated and the single playback device 110 and/or the single NMD 120 may communicate directly with the remote control devices 106a-c. In some embodiments, a telecommunication network (e.g., an LTE network, a 5G network, etc.) may communicate with the various playback devices 110, network microphone devices 120, and/or control devices 130 independent of the local network 160.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, BLUETOOTH, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., media content comprising music and/or other sounds) from a local audio source 150 via the input/output 111 (e.g., a cable, a wire, a PAN, a BLUETOOTH connection, an ad hoc wired or wireless communication network, and/or another suitable communication link). The local audio source 150 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 150 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 150. In other embodiments, however, the media playback system omits the local audio source 150 altogether. In some embodiments, the playback device 110a does not include an input/output 111 and receives all media content via the local network 160.

The playback device 110a further comprises electronics 112, a user interface 113 (e.g., one or more buttons, knobs, dials, touch-sensitive surfaces, displays, touchscreens), and one or more transducers 114 (e.g., a driver), referred to hereinafter as “the transducers 114.” The electronics 112 is configured to receive audio from an audio source (e.g., the local audio source 150) via the input/output 111, one or more of the control devices 106a-c via the local network 160 (FIG. 1B), amplify the received audio, and output the amplified audio for playback via one or more of the transducers 114. In some embodiments, the playback device 110a optionally includes one or more microphones (e.g., a single microphone, a plurality of microphones, a microphone array) (hereinafter referred to as “the microphones”). In certain embodiments, for example, the playback device 110a having one or more of the optional microphones can operate as an NMD configured to receive voice input from a user and correspondingly perform one or more operations based on the received voice input, which will be discussed in more detail further below with respect to FIGS. 1F and 1G.

In the illustrated embodiment of FIG. 1C, the electronics 112 comprise one or more processors 112a (referred to hereinafter as “the processors 112a”), memory 112b, software components 112c, a network interface 112d, one or more audio processing components 112g, one or more audio amplifiers 112h (referred to hereinafter as “the amplifiers 112h”), and power components 112i (e.g., one or more power supplies, power cables, power receptacles, batteries, induction coils, Power-over Ethernet (POE) interfaces, and/or other suitable sources of electric power).

In some embodiments, the electronics 112 optionally include one or more other components 112j (e.g., one or more sensors, video displays, touchscreens, battery charging bases). In some embodiments, the playback device 110a and electronics 112 may further include one or more voice processing components that are operably coupled to one or more microphones, and other components as described below with reference to FIGS. 1F and 1G.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the control devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of media content with another of the one or more playback devices 110. As those of ordinary skill in the art will appreciate, during synchronous playback of media content on a plurality of playback devices, a listener will preferably be unable to perceive time-delay differences between playback of the media content by the playback device 110a and the other one or more other playback devices 110. Additional details regarding audio playback synchronization among playback devices and/or zones can be found, for example, in U.S. Pat. No. 8,234,395 entitled “System and method for synchronizing operations among a plurality of independently clocked digital data processing devices,” which is herein incorporated by reference in its entirety.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the MPS 100. In some aspects, for example, the state data is shared during predetermined intervals of time (e.g., every 5 seconds, every 10 seconds, every 60 seconds) among at least a portion of the devices of the MPS 100, so that one or more of the devices have the most recent data associated with the MPS 100.

The network interface 112d is configured to facilitate a transmission of data between the playback device 110a and one or more other devices on a data network. The network interface 112d is configured to transmit and receive data corresponding to media content (e.g., media content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the local network 160 (FIG. 1B) in accordance with a suitable wireless communication protocol (e.g., WiFi, BLUETOOTH, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

In some implementations, the power components 112i of the playback device 110a may additionally include an internal power source (e.g., one or more batteries) configured to power the playback device 110a without a physical connection to an external power source. When equipped with the internal power source, the playback device 110a may operate independent of an external power source. In some such implementations, an external power source interface may be configured to facilitate charging the internal power source. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The user interface 113 may facilitate user interactions independent of or in conjunction with user interactions facilitated by one or more of the control devices 130 (FIG. 1A). In various embodiments, the user interface 113 includes one or more physical buttons and/or supports graphical interfaces provided on touch sensitive screen(s) and/or surface(s), among other possibilities, for a user to directly provide input. The user interface 113 may further include one or more light components (e.g., LEDs) and the speakers to provide visual and/or audio feedback to a user.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

In some embodiments, the playback device 110a may include a speaker interface for connecting the playback device to external speakers. In other embodiments, the playback device 110a may include an audio interface for connecting the playback device to an external audio amplifier or audio-visual receiver.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” “SUB,” “BEAM,” “ARC,” “MOVE,” and “ROAM,” among others. Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more of the playback devices 110 may comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device may omit a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency media content, and the playback device 110i is a subwoofer configured to render low frequency media content. In some aspects, the playback device 110a, when bonded with playback device 110i, is configured to render only the mid-range and high frequency components of a particular media content, while the playback device 110i renders the low frequency component of the particular media content. In some embodiments, the bonded playback device 110q includes additional playback devices and/or another bonded playback device.

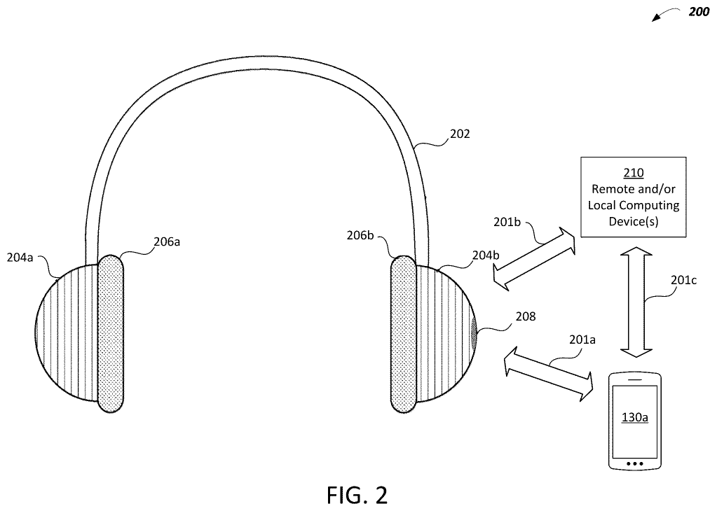

In some embodiments, one or more of the playback devices 110 may take the form of a wired and/or wireless headphone device (e.g., over-ear headphones, on-ear headphones, in-car earphones, etc.). For instance, FIG. 2 shows an example headset assembly 200 (“headset 200”) for such an implementation of one of the playback devices 110. As shown, the headset 200 includes a headband 202 that couples a first carcup 204a to a second carcup 204b. Each of the carcups 204a and 204b may house any portion of the electronic components in the playback device 110, such as one or more speakers. Further, one or both of the carcups 204a and 204b may include a user interface for controlling audio playback, volume level, and other functions. The user interface may include any of a variety of control elements such as a physical button 208, a slider (not shown), a knob (not shown), and/or a touch control surface (not shown). As shown in FIG. 2, the headset 200 may further include car cushions 206a and 206b that are coupled to carcups 204a and 204b, respectively. The car cushions 206a and 206b may provide a soft barrier between the head of a user and the carcups 204a and 204b, respectively, to improve user comfort and/or provide acoustic isolation from the ambient (e.g., passive noise reduction (PNR)).

As described in greater detail below, the electronic components of a playback device may include one or more network interface components (not shown in FIG. 2) to facilitate wireless communication over one more communication links. For instance, a playback device may communicate over a first communication link 201a (e.g., a BLUETOOTH link) with one of the control devices 130, such as the control device 130a, and/or over a second communication link 201b (e.g., a WiFi or cellular link) with one or more other control devices 210 (e.g., a network router and/or a remote server). As another possibility, a playback device may communicate over multiple communication links, such as the first communication link 201a with the control device 130a and a third communication link 201c (e.g., a WiFi or cellular link) between the control device 130a and the one or more other control devices 210. Thus, the control device 130a may function as an intermediary between the playback device and the one or more other control devices 210, in some embodiments.

In some instances, the headphone device may take the form of a hearable device. Hearable devices may include those headphone devices (including car-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.)

It should be appreciated that one or more of the playback devices 110 may take the form of other wearable devices separate and apart from a headphone device. Wearable devices may include those devices configured to be worn about a portion of a user (e.g., a head, a neck, a torso, an arm, a wrist, a finger, a leg, an ankle, etc.). For example, the playback devices 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an car of the subject.

### c. Suitable Network Microphone Devices (NMDs)

FIG. 1F is a block diagram of the NMD 120a (FIGS. 1A and 1B). The NMD 120a includes one or more voice processing components 124 and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise any or all of the components of the playback device 110a and further include the microphones 115 and voice processing components 124 (FIG. IF). The microphones 115 are configured to detect sound (i.e., acoustic waves) in the environment of the playback device 110r, which may then be provided to voice processing components 124. More specifically, each microphone 115 is configured to detect sound and convert the sound into a digital or analog signal representative of the detected sound, which can then cause the voice processing component to perform various functions based on the detected sound, as described in greater detail below. In some implementations, the microphones 115 may be arranged as an array of microphones (e.g., an array of six microphones). In some implementations the playback device 110r may include fewer than six microphones or more than six microphones. The playback device 110r optionally includes an integrated control device 130c. The control device 130c can comprise, for example, a user interface configured to receive user input (e.g., touch input, voice input) without a separate control device. In other embodiments, however, the playback device 110r receives commands from another control device (e.g., the control device 130a of FIG. 1B).

In operation, the voice-processing components 124 are generally configured to detect and process sound received via the microphones 115, identify potential voice input in the detected sound, and extract detected-sound data to enable a VAS, such as the VAS 190 (FIG. 1B), to process voice input identified in the detected-sound data. The voice processing components 124 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 124 may include or otherwise take the form of one or more DSPs or one or more modules of a DSP. In this respect, certain voice processing components 124 may be configured with particular parameters (e.g., gain and/or spectral parameters) that may be modified or otherwise tuned to achieve particular functions. In some implementations, one or more of the voice processing components 124 may be a subcomponent of the processor 112a.

In some implementations, the voice-processing components 124 may detect and store a user's voice profile, which may be associated with a user account of the MPS 100. For example, voice profiles may be stored as and/or compared to variables stored in a set of command information or data table. The voice profile may include aspects of the tone of frequency of a user's voice and/or other unique aspects of the user's voice, such as those described in previously-referenced U.S. Pat. No. 10,499,146.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The NMD 120a may use the microphone data (or transmit the microphone data to another device) for calibrating the audio characteristics of one or more playback devices 110 in the MPS 100. As another example, one or more of the playback devices 110, NMDs 120, and/or control devices 130 of the MPS 100 may transmit audio tones (e.g., ultrasonic tones, infrasonic tones) that may be detectable by the microphones 115 of other devices, and which may convey information such as a proximity and/or identity of the transmitting device, a media playback system command, etc. As yet another example, the voice processing components 124 may receive and analyze the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

### d. Suitable Controller Devices

FIG. 1H is a partially schematic diagram of one example of the control device 130a (FIGS. 1A and 1B). As used herein, the term “control device” can be used interchangeably with “controller,” “controller device,” or “control system.” Among other features, the control device 130a is configured to receive user input related to the MPS 100 and, in response, cause one or more devices in the MPS 100 to perform an action(s) and/or an operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the MPS 100. In other embodiments, as described above with respect to FIG. 1G, the control device 130a is integrated into another device in the MPS 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processor(s) 132a”), a memory 132b, software components 132c, and a network interface 132d. The processor(s) 132a can be configured to perform functions relevant to facilitating user access, control, and configuration of the MPS 100. The memory 132b can comprise data storage that can be loaded with one or more of the software components executable by the processors 132a to perform those functions. The software components 132c can comprise applications and/or other executable software configured to facilitate control of the MPS 100. The memory 132b can be configured to store, for example, the software components 132c, media playback system controller application software, and/or other data associated with the MPS 100 and the user.

The network interface 132d is configured to facilitate network communications between the control device 130a and one or more other devices in the MPS 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.12, 802.11ac, 802.15, 4G, LTE). The network interface 132d can be configured, for example, to transmit data to and/or receive data from the playback devices 110, the NMDs 120, other ones of the control devices 130, one of the control devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, media content selection) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among other changes. Additional description of zones and groups can be found below with respect to FIGS. 1J through 1N.

The user interface 133 is configured to receive user input and can facilitate control of the MPS 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133c. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system. FIG. 1I shows two additional example user interface displays 133f and 133g of user interface 133. Additional examples are also possible.

The one or more speakers 134 (e.g., one or more transducers) can be configured to output sound to the user of the control device 130a. In some embodiments, the one or more speakers 134 comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

### e. Suitable Playback Device Configurations

FIGS. 1J, 1K, 1L, 1M, and 1N show example configurations of playback devices in zones and zone groups. Referring first to FIG. 1N, in one example, a single playback device may belong to a zone. For example, the playback device 110g in the Second Bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities), as will be described in more detail further below. In other implementations, multiple playback devices may be merged to form a single zone. As one example, the playback device 110a can be bonded to the playback device 110n and the NMD 120c to form Zone A. As another example, the playback device 110h (e.g., a front playback device) may be merged with the playback device 110i (e.g., a subwoofer), and the playback devices 110j and 110k (e.g., left and right surround speakers, respectively) to form a single Zone D. In yet other implementations, one or more playback zones can be merged to form a zone group (which may also be referred to herein as a merged group). As one example, the playback zones Zone A and Zone B can be merged to form Zone Group 108a. As another example, the playback zones Zone G and Zone H can be merged to form Zone Group 108b. The merged playback zones Zone G and Zone H may not be specifically assigned different playback responsibilities. That is, the merged playback zones Zone G and Zone H may, aside from playing media content in synchrony, each play media content as they would if they were not merged and operating as independent zones.

Each zone in the MPS 100 may be represented for control as a single user interface (UI) entity. For example, Zone A may be represented as a single entity named Master Bathroom. Zone B may be represented as a single entity named Master Bedroom. Zone C may be represented as a single entity named Second Bedroom.

In some implementations, as mentioned above playback devices that are bonded may have different playback responsibilities, such as responsibilities for certain audio channels. For example, as shown in FIG. 1J, the playback devices 110l and 110m may be bonded so as to produce or enhance a stereo effect of media content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1K, the playback device 110h named Front may be bonded with the playback device 110i named SUB. The Front device 110h can be configured to render a range of mid to high frequencies and the SUB playback device 110i can be configured to render low frequencies. When unbonded, however, the Front device 110h can be configured to render a full range of frequencies. As another example, FIG. IL shows the Front and SUB playback devices 110h and 110i further bonded with Left and Right playback devices 110j and 110k, respectively. In some implementations, the Right and Left devices 110j and 110k can be configured to form surround or “satellite” channels of a home theater system. The bonded playback devices 110h, 110i, 110j, and 110k may form a single Zone D (FIG. 1N).

In other implementations, playback devices that are merged may not have assigned playback responsibilities and may each render the full range of media content of which the respective playback device is capable. Nevertheless, merged devices may be represented as a single UI entity (i.e., a zone, as discussed above). For instance, the playback devices 110a and 110n in the Master Bathroom have the single UI entity of Zone A. In one embodiment, the playback devices 110a and 110n may each output the full range of media content of which each respective playback devices 110a and 110n is capable, in synchrony.

In some embodiments, an NMD may be bonded or merged with one or more other devices so as to form a zone. As one example, the NMD 120c may be merged with the playback devices 110a and 110n to form Zone A. As another example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. Pat. No. 10,499,146.

As mentioned above, in some implementations, zones of individual, bonded, and/or merged devices may be grouped to form a zone group. For example, referring to FIG. 1N, Zone A may be grouped with Zone B to form a zone group 108a that includes the two zones, and Zone G may be grouped with Zone H to form the zone group 108b. However, other zone groupings are also possible. For example, Zone A may be grouped with one or more other Zones C-I. The Zones A-I may be grouped and ungrouped in numerous ways. For example, three, four, five, or more (e.g., all) of the Zones A-I may be grouped at any given time. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back media content.

In various implementations, the zone groups in an environment may be named by according to a name of a zone within the group or a combination of the names of the zones within a zone group. For example, Zone Group 108b can be assigned a name such as “Dining +Kitchen”, as shown in FIG. 1N. In other implementations, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the Second Bedroom 101c may indicate (i) that the playback device 110g is the only playback device of the Zone C and (ii) that Zone C is not in a zone group. Identifiers associated with the Den 101d may indicate that the Den 101d is not grouped with other zones but includes bonded playback devices 110h-110k. Identifiers associated with the Dining Room 101g may indicate that the Dining Room 101g is part of the Dining+Kitchen Zone Group 108b and that devices 110d and 110b (Kitchen 101h) are grouped (FIGs. 1M, 1N). Identifiers associated with the Kitchen 101h may indicate the same or similar information by virtue of the Kitchen 101h being part of the Dining+Kitchen Zone Group 108b. Other example zone variables and identifiers are described below.

In yet another example, the MPS 100 may include variables or identifiers representing other associations of zones and zone groups, such as identifiers associated with Areas, as shown in FIG. 1N. An area may involve a cluster of zone groups and/or zones not within a zone group. For instance, FIG. 1N shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, issued Jul. 14, 2020, and titled “Room Association Based on Name,” and U.S. Pat. No. 8,483,853, filed Sep. 11, 2007, issued Jul. 9, 2013, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

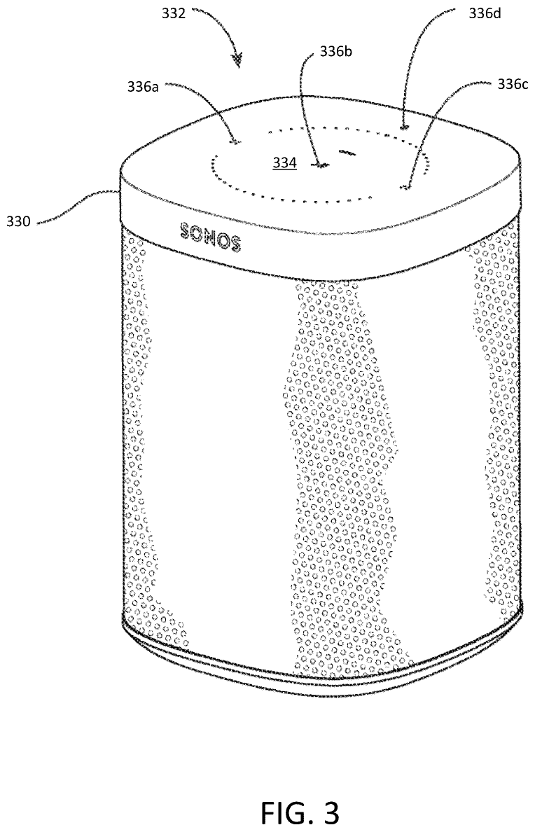

FIG. 3 shows an example housing 330 of a playback device (e.g., one of the playback devices 110 discussed above) that includes a user interface in the form of a control area 332 at a top portion 334 of the housing 330. The control area 332 includes buttons 336a, 336b, and 336c for controlling audio playback, volume level, and other functions. The control arca 332 also includes a button 336d for toggling one or more microphones (not visible in FIG. 3) of the playback device 110 to either an on state or an off state. The control area 332 is at least partially surrounded by apertures formed in the top portion 334 of the housing 330 through which the microphones receive the sound in the environment of the playback device. The microphones may be arranged in various positions along and/or within the top portion 334 or other areas of the housing 330 so as to detect sound from one or more directions relative to the playback device.

### f. Media Content

Media content may be any type of media content now known or later developed. For example, in some embodiments, the media content includes any one or more of: (i) streaming music or other audio obtained from a streaming media service, such as Spotify, Pandora, or other streaming media services; (ii) streaming music or other audio from a local music library, such as a music library stored on a user's laptop computer, desktop computer, smartphone, tablet, home server, or other control device now known or later developed; (iii) media content associated with video content, such as audio associated with a television program or movie received from any of a television, set-top box, Digital Video Recorder, Digital Video Disc player, streaming video service, or any other source of audio-visual media content now known or later developed; (iv) text-to-speech or other audible content from a voice assistant service (VAS), such as Amazon Alexa or other VAS services now known or later developed; (v) media content from a doorbell or intercom system such as Nest, Ring, or other doorbells or intercom systems now known or later developed; and/or (vi) media content from a telephone, video phone, video/teleconferencing system or other application configured to allow users to communicate with each other via audio and/or video.

Media content that can be played by a playback device as described herein, including any of the aforementioned types of media content, may also be referred to herein as media content. A source from which the media content is obtained may be referred to herein as a media content source.

In operation, a “sourcing” playback device obtains any of the aforementioned types of media content from an audio source via an interface on the playback device, e.g., one of the sourcing playback device's network interfaces, a “line-in” analog interface, a digital audio interface, or any other interface suitable for receiving media content in digital or analog format now known or later developed.

An audio source is any system, device, or application that generates, provides, or otherwise makes available any of the aforementioned media content to a playback device. For example, in some embodiments, an audio source includes any one or more of a streaming media (audio, video) service, digital media server or other computing system, VAS service, television, cable set-top-box, streaming media player (e.g., AppleTV, Roku, gaming console), CD/DVD player, doorbell, intercom, telephone, tablet, or any other source of digital media content.

A playback device that receives or otherwise obtains media content from an audio source for playback and/or distribution to other playback devices may be referred to herein as the “sourcing” playback device, “master” playback device, or “group coordinator.” One function of the “sourcing” playback device is to process received media content for playback and/or distribution to other playback devices. In some embodiments, the sourcing playback device transmits the processed media content to all the playback devices that are configured to play the media content. In some embodiments, the sourcing playback device transmits the processed media content to a multicast network address, and all the other playback devices configured to play the media content receive the media content via that multicast address. In some embodiments, the sourcing playback device alternatively transmits the processed media content to each unicast network address of each other playback device configured to play the media content, and each of the other playback devices configured to play the media content receive the media content via its unicast address.

### III. Example Operations of a Community Playback Device

As discussed above, in addition to offering robust media playback system (MPS) solutions for customers, Sonos is also able to provide the unique Sonos listening experience to a wider audience through the implementation of community media playback systems (CMPS). In practice, a CMPS may comprise one or more community playback devices in a community space that operate to provide a community media playback experience to listeners in the community space. The various operations that community playback devices may be configured to perform to provide a community media playback experience are described in greater detail below.

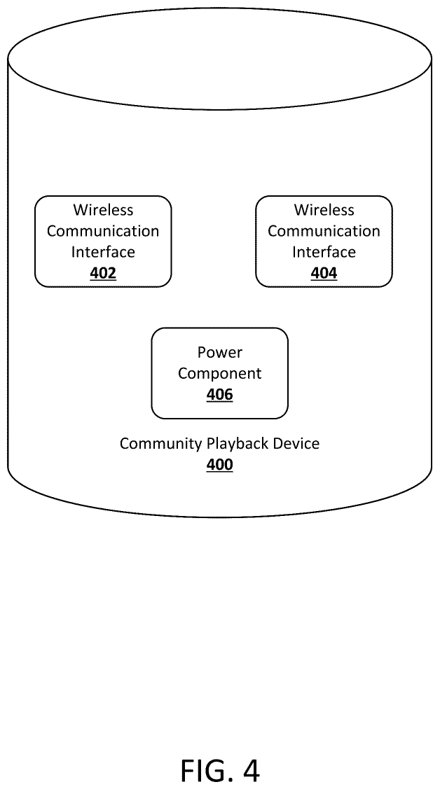

Turning now to FIG. 4, a schematic block diagram of a community playback device 400 is shown, which may be part of a CMPS comprising one or more community playback devices that may be configured to provide community media playback experiences when positioned in a community space, according to the present disclosure. In practice, the community playback device 400 may be one of the playback devices 110 that further includes various components and functionality described below, or the community playback device 400 may be a different playback device that includes various of the components and functionality of the playback devices 110 previously described in addition to other components described below.

The community playback device 400 may include a first wireless communication interface 402 for communicating over a wide area network (WAN). The first wireless communication interface may take various forms. As one possibility, the first wireless communication interface 402 may comprise a cellular radio or the like to enable the community playback device 400 to communicate over the WAN via a connection to a cellular network (e.g., 3G, 4G, 5G, etc.). As another possibility, the first wireless communication interface 402 may comprise circuitry to enable the community playback device 400 to communicate over the WAN via a WiFi connection (e.g., via connection to a WiFi access point that is connected to the WAN). The circuitry that enables the WiFi connection may include a suitable interface comprising one or more antennas, among various other things. The first wireless communication interface 402 may comprise various other circuitry as well to enable the community playback device 400 to communicate over the WAN.

In some implementations, the community playback device 400 may utilize the first wireless communication interface 402 to retrieve media content for playback, e.g., via communications with an audio source over the WAN. As previously mentioned, the audio source may take any of various forms, one example being a streaming media service.

The community playback device 400 may also include a second wireless communication interface 404 for communicating with controller devices, other playback devices (e.g., community playback devices in the CMPS), or both. In practice, the second wireless communication interface 404 may be similar to the wireless interface 112e described above with respect to the playback devices 110. The second wireless communication interface 404 may comprise circuitry that enables the community playback device 400 to communicate with the controller devices and/or playback devices via a WiFi connection, a Bluetooth connection, among various other possibilities.

In some implementations, the community playback device 400 may utilize the second wireless communication interface 404 to provide an access point to enable other community playback devices in the CMPS to connect to a WAN. In some situations, the other community playback devices may not otherwise be able to do so (e.g., due to poor connectivity, due to the absence of an interface for connecting to the WAN via a cellular connection, etc.). For example, in a situation where a WAN is only able to be accessed by community playback devices is a given CMPS via a cellular connection, only a subset of the community playback devices in the CMPS (e.g., only the community playback device 400) may be able to establish a cellular connection to the WAN via the first wireless communication interface 402. To enable the other community playback devices in the CMPS to connect to the WAN, the community playback device 400 may relay communications to and from the other community playback devices in the CMPS via the second wireless communication interface 404 (e.g., WiFi or Bluetooth communications) that enable the other community playback devices in the CMPS to establish respective connections to the WAN.

In some implementations, functionality of the first wireless communication interface 402 and the second wireless communication interface 404 may be provided by a single wireless communication interface, such that the community playback device 400 may only include a single wireless communication interface that provides the functionalities of the first wireless communication interface 402 and the second wireless communication interface 404 discussed above. Various other possibilities may also exist.

The community playback device 400 may also include a power component 406, which may be an integrated power source. In some implementations, the power component 406 may comprise an integrated energy harvesting power source, so that the power component 406 is able to recharge via its energy harvesting capabilities (e.g., via solar panels, wind turbines, physical generators, etc.), rather than requiring external power management (e.g., battery replacement, plugging into an external source of power, etc.). This may be beneficial, particularly in implementations where the community playback device 400 is positioned in a location where it may be difficult to otherwise run dedicated power (e.g., in a remote location without convenient access to electricity). Alternatively, the power component 406 may be an interface for connecting to an external power source, which may also comprise energy harvesting capabilities as previously described. Various other possibilities may also exist, including (i) the power component 406 comprising batteries, which may be replaceable and/or rechargeable and (ii) the power component 406 comprising an interface for connecting to a power source such as an outlet or generator, among various other possibilities.

The community playback device 400 may also include other components, such as memory 112b as shown and described with respect to FIG. 1C. The community playback device 400 may be configured to retrieve media content from one or more audio sources (e.g., via the first wireless communication interface 402) and store it in the memory 112b. In some implementations, this may help mitigate connectivity issues between the community playback device 400 and audio sources, allowing the community playback device 400 to play back media content from the memory 112b, for example, when the community playback device 400 is unable to retrieve media content from other audio sources. Accordingly, the community playback device 400 may be configured to retrieve various amounts of media content (e.g., 1000 tracks, among various other quantities) from audio sources and store them in the memory 112b for future use.

Further, the type of media content that the community playback device 400 may retrieve and store in the memory 112b may take various forms. For example, the community playback device 400 may selectively retrieve and store certain media content based on factors such as (i) the popularity of certain media content (e.g., based on playback via the community playback device 400, based on playback by other media playback systems in a local area such as the same city, or based on more global playback trends across all media playback systems, etc.), (ii) one or more contexts of a community space wherein the community playback device 400 may be positioned, (iii) one or more requests indicating media content from one or more controller devices, (iv) royalty-free media content, and/or (v) promotions for certain media content, for example, by certain providers of media content (e.g., artists, record labels, etc.), among various other possibilities. Further, the media content may take the form of a song, a playlist, an album, a radio stream or other content streaming service, etc.

As mentioned, the community playback device 400 may be configured to provide a community media playback experience when positioned in a community space. In practice, setting up the community playback device 400 to provide a community media playback experience in the community space may involve various operations. For example, setup of the community playback device 400 may involve connecting the community playback device 400 to a WAN, as previously described.

Setup of the community playback device 400 may also involve establishing one or more facilitators of the community space (e.g., a facilitator account) that may have privileged access to certain features of the community playback device 400. Facilitator features may include the ability to restrict certain media content from being played back by the community playback device 400, adding additional community playback devices to the CMPS, adding media content sources, providing context information to the community playback device 400, among various others, as described in greater detail below.

Setup of the community playback device 400 may also involve connecting the community playback device 400 to one or more other community playback devices in a given CMPS. As suggested above, this may enable the one or more other community playback devices to establish a connection to the WAN, as previously described.

Setup of the community playback device 400 may also involve determining a context of the community space. In practice, the community playback device 400 may determine a context of the community space based on various factors, such as (i) a schedule of events for the community space that the community playback device 400 may receive, for example, from a facilitator of the community space or elsewhere, (ii) typical activities of the community space (e.g., a recreation center may typically be used for sports, group classes, community organization meetings, etc.), (iii) input received from a facilitator of the community space identifying the context, (iv) detected audio or motion in the community space from sound sensors, passive infrared (PIR) sensors, and the like, and/or (v) historical information that describes (a) what media content has previously been played at the community space, (b) at what volume(s) media content has previously been played at the community space, and/or (c) at what time(s) media content has previously been played back at the community space, among various other possibilities.

Various other setup operations may also exist. Further, in some implementations, one or more of the setup operations discussed may not be performed. Further yet, in some implementations, certain setup operations of the community playback device 400 may occur at other times than when the community playback device is initially set up in the community space. For example, a facilitator may update the community playback device 400 at various times using one or more of the setup operations described.

Various other operations that may be carried out to set up a playback device are described in U.S. Patent Pub. No. 2022/0104015, entitled “Intelligent Setup for Playback Devices,” which is incorporated by reference herein in its entirety.

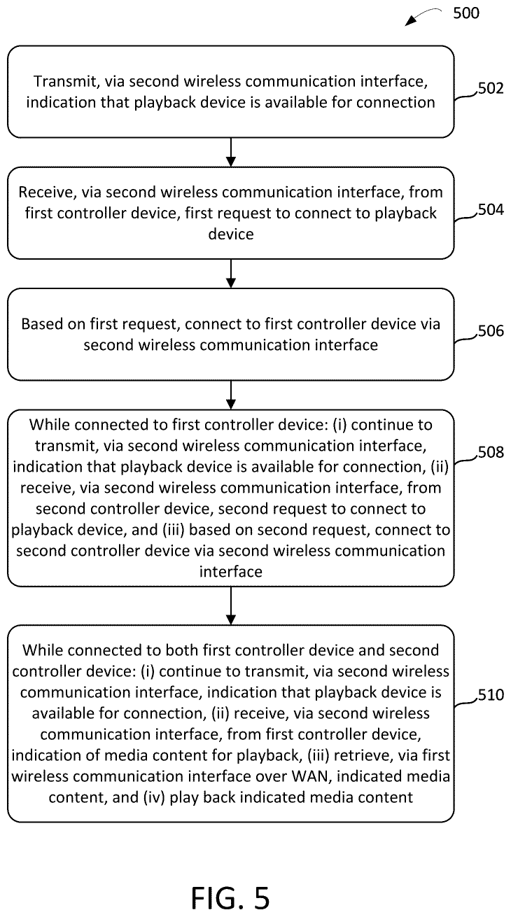

Turning now to FIG. 5, a flowchart 500 is shown illustrating various operations that may be carried out by the community playback device 400 to provide a community media playback experience, according to the present disclosure.

Beginning at block 502, the community playback device 400 may transmit an indication that the community playback device 400 is available for connection. In practice, the community playback device 400 may transmit this indication via the second wireless communication interface 404.

The community playback device 400 may be available for connection when certain criteria are met. One possible criteria may be that the community playback device 400 is connected to a power supply. Another possible criteria may be that the community playback device 400 has established a secure connection to a WAN, which in some implementations may be accomplished as part of a setup process as previously described. Yet another possible criteria may be that a facilitator of the community playback device 400 has enabled the community playback device 400 for connection. Various other criteria may also exist. Further, in some implementations, not every listed criteria may be required for the community playback device 400 to be available for connection. For example, the community playback device 400 may be available for connection despite not having established a secure connection to a WAN. In such an example, the community playback device 400 may be configured to retrieve media content from its own memory, or from a local audio source (e.g., similar to the local audio source 150 shown in FIG. 1C), rather than from a streaming media service, as previously described, to provide a community media playback experience. Various other examples may also exist.

In practice, the community playback device 400 may transmit the indication that the community playback device 400 is available in various ways. As one example, the indication may take the form of a WiFi broadcast message, which may be received by any controller device that can detect WiFi broadcast messages and is within WiFi range of the community playback device 400. As another example, the indication may take the form of a Bluetooth beacon, which may be detected by any Bluetooth-enabled controller device within range. Other possibilities also exist.

At block 504, the community playback device 400 may receive, from a first controller device, a first request to connect to the community playback device 400. In practice, the community playback device 400 may receive the first request from the first controller device via the second wireless communication interface 404, for example, via Wifi, Bluetooth, among various other possibilities.

In practice, there may be various community playback devices that the first controller device may be able to transmit a request for connection. For instance, the first controller device may receive (i) a first indication from the community playback device 400 that the community playback device 400 is available for connection and (ii) a second indication from a different community playback device that the different community playback device is available for connection. This may occur in situations where the first controller device is within a signal range of two community spaces, or possibly when there are multiple community playback devices in a given community space. Accordingly, various methods may be employed to intelligently determine that the request transmitted by the first controller device is received by the intended community playback device (e.g., the community playback device 400).

As one possibility, the indication transmitted by the community playback device 400 may include a unique identifier that the first controller device may utilize to send the request for connection to the community playback device 400. For example, the controller device may include a PIN included in the indication transmitted by the community playback device 400 in the request it sends out, which the community playback device 400 may identify and subsequently process the request. In such a case, community playback devices that are not identified in the request may determine to not process the request.

As yet another possibility, the community playback device 400 may output an audio tone (e.g., a “chirp” or other audio signal that may or may not be audible to a human listener) that includes information identifying the community playback device 400. The first controller device, in turn, may detect the audio tone and use the included information to confirm that it is within a listening proximity to the community playback device 400, and thereby mutually authenticate with the community playback device 400 that it is the intended controller device for connection.

As still yet another possibility, the community playback devices may be configured to determine whether the strength of a signal received from the first controller device meets/exceeds a threshold signal strength. For instance, if the community playback device 400 determines that the strength of the signal received from the first controller device meets/exceeds a threshold signal strength, then the community playback device 400 may receive and process the request for connection from the first controller device.

Various other possibilities may also exist, including near-field communications (NFC), ultra-wideband (UWB) communications, and/or a button press on the community playback device 400. Many of these authentication techniques are described in more detail in U.S. Patent Pub. No. 2022/0104015, incorporated by reference above.

In practice, the first controller device may be installed with the MPS controller application. In this regard, the MPS controller application may be all that is required to access a community playback device, whether or not a user of the first controller device opts to create an associated user account. In some implementations, when the community playback device 400 has been identified by the first controller device (e.g., from among various other community playback devices near the controller device), a visualization indicating the community playback device 400 may be presented via the MPS controller application.

In practice, the first controller device may send the request for connection in various ways.

As one possibility, the first controller device may, via the MPS controller application, automatically send the first request. For example, upon entering a proximity of the community playback device 400 and detecting the indication that the community playback device 400 is available for connection, the first controller device may be configured to automatically send the first request to the community playback device 400.

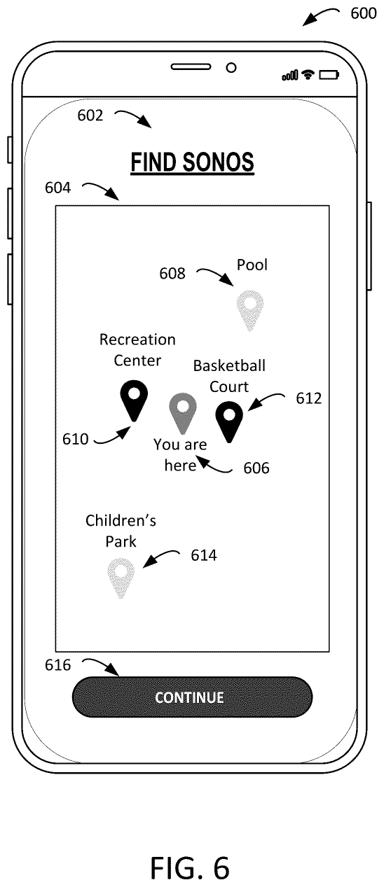

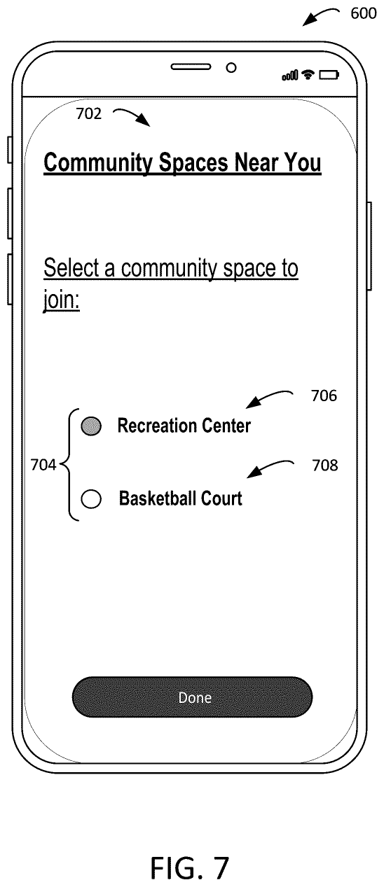

As another possibility, a user of the first controller device may open the MPS controller application and interact with the MPS controller application to send the first request. For example, the MPS controller application may provide a notification that the community playback device 400 is available for connection. FIGS. 6 and 7 provide some examples as to how a user of a controller device may (i) identify the given community playback device 400 for connection and (ii) submit the request received by the community playback device 400 at block 504.

FIG. 6 depicts a diagram of a controller device 600 (which may be the first controller device discussed above) presenting an example visualization 602 of the MPS controller application for enabling users to find a community space that includes a community playback device. As shown, the example visualization 602 includes a header “FIND SONOS,” indicating that a user may utilize the example visualization 602 to find a community space that includes at least one Sonos playback device that has been set up as a community playback device.

Further, the example visualization 602 includes a map 604, which may represent a geographical area surrounding the controller device 600. Additionally or alternatively, the map 604 may represent a geographical area other than where the controller device 600 is located. For example, the example visualization 602 may include control options to enable a user of the controller device 600 to navigate the map 604 to show various geographical locations beyond the immediate surroundings of the controller device 600.

In any event, the map 604 may include various indications (e.g., pins, flags, or the like) to indicate locations of various community playback devices. As shown in FIG. 6, the map 604 includes a pin 606, which indicates a location of the controller device 600. The location of the controller device 600 indicated by the pin 606 may be a current location of the controller device 600, or possibly a recent or planned location of the controller device 600. As may be appreciated, in some implementations the pin 606 may be absent from the map 604, for example, in implementations where the map 604 is showing a geographical location beyond the location of the controller device 600.

The map 604 also includes various other pins representing locations of community spaces that include one or more community playback devices. As shown, the map 604 includes (i) a pin 608 indicating a location of a pool community space including one or more community playback devices, (ii) a pin 610 indicating a location of a recreation center community space including one or more community playback devices, (iii) a pin 612 indicating a location of a basketball court community space including one or more community playback devices, and (iv) a pin 614 indicating a location of a children's park community space including one or more community playback devices. As may be appreciated, there may be various other pins presented on the map 604.

Further, in some implementations, the pins on the map 604 may represent community spaces that include one or more community playback devices that are ready for connection, or possibly that will be ready for connection in the near future, for instance, in implementations where the community playback devices of a given community space are scheduled to be ready for connection for a given scheduled event at the given community space.

The MPS controller application may have access to a remote server or other database that includes information identifying the locations of the community playback devices that are to be referenced in the map 604. For example, a given community playback device may provide identifying information to the remote server, including details such as (i) a unique identifier for the given community playback device, (ii) a GPS location for the given community playback device, (iii) an online/offline status for the given community playback device, (iv) a setup completion status for the given community playback device, (v) a schedule of times that the given community playback device will be ready for connection, (vi) a name or description of a given community space wherein the given community playback device is positioned, among various other possibilities. Some or all of this information may be provided by the community playback device during initial setup operations, or at various times thereafter. Accordingly, the MPS controller application may retrieve the identifying information for community playback devices in the given geographical location from the remote server. The controller device 600 may then populate the map 604 with respective pins corresponding to one or more community playback devices identified for the given geographical location represented via the map 604.

Further, certain of the pins 608-614 may be marked to signify that the controller device 600 is close enough to send a request for connecting to community playback devices of the community spaces represented by the marked pins. As shown, this may include the pin 610 representing the recreation center community space and the pin 612 representing the basketball court community space, which are darker in color than the pins 608 and 614. For example, the community playback devices of the pool community space and the children's park community space represented by the pins 608 and 614, respectively, may not be close enough to the controller device 600 to establish a connection.

In some implementations, a user of the controller device 600 may interact with the pins 608-614 to send requests to connect to the community playback devices represented by the pins 608-614. As one example, a user selection of the pin 608 may cause the controller device 600 to present an indication that the controller device 600 is not close enough to community playback devices of the pool community space represented by the pin 608, as well as a suggestion to try again when the controller device 600 is close to the pool community space represented by the pin 608. In some implementations, the controller device 600 may also present directions to the pool community space, as well as possibly an indication of a required proximity to establish a connection.

As another example, a user selection of the pin 612 may cause the controller device 600 to send a request for connecting to one or more community playback devices in the basketball court community space represented by the pin 612. Various other examples may also exist.

Further, the example visualization 602 includes a selectable icon 616 for continuing to a Community Space Selection visualization, one example of which is shown in FIG. 7. FIG. 7 depicts a diagram of the controller device 600, which is shown presenting an example visualization 702 of the media playback system controller application software that may be presented in response to a user selection of the selectable icon 616 of FIG. 6. Further, the controller device 600 may present the example visualization 702 in response to various other triggers as well.

The example visualization 702 presented via the controller device 600 may provide functionality to enable a user of the controller device 600 to select a nearby community playback device for connection. For instance, the example visualization 702 includes a list 704 of one or more community spaces that include one or more community playback devices with which the controller device 600 is able to establish a connection. As shown, the list 704 includes (i) a selectable icon 706 for a recreation center community space including one or more community playback devices and (ii) a selectable icon 708 for a basketball court community space including one or more community playback devices. As an example, the selectable icon 706 may be for the recreation center represented by the pin 610 of FIG. 6, and the selectable icon 708 may be for the basketball court community space represented by the pin 612 of FIG. 6.

Further, in this example, neither the pool community space nor the children's park community space are included in the list 704. For instance, due to the controller device's positioning between the recreation center community space and the basketball court community space (as shown via the pins 606, 610, and 612, respectively), the recreation center and the basketball court may be the only community spaces that are close enough for the controller device 600 to detect the indications that the community playback devices are available and then responsively request a connection. Accordingly, the recreation center community space and the basketball center community space are included in the list 704, whereas the pool community space and the children's park community space, which are too far away for the controller device 600 to detect the indications of available community playback devices, are not.

As shown, the selectable icon 706 has been selected via user input. Accordingly, the controller device 600 may transmit a request to connect with one or more community playback devices of the recreation center. For instance, the community playback device 400 may be positioned in the recreation center, and in response to the user selection of the selectable icon 706, the controller device 600 may transmit a request to the community playback device 400 for connection, which the community playback device 400 may receive as described with respect to block 504.

Returning to FIG. 5, at block 506, the community playback device 400 may, based on the first request, connect to the first controller device. In practice, the community playback device 400 may connect to the first controller device via the second wireless communication interface 404.

The community playback device 400 may connect to the first controller device via the second wireless communication interface 404 in various manners. As one possibility, in a scenario where the community playback device is connected to a WAN via a cellular connection, the community playback device 400 may act as an access point for a local area network (LAN), such as an 802.11 WiFi network, and the first controller device may connect to the LAN provided by the community playback device 400. To illustrate with an example, a user may bring their controller device within proximity to the community playback device 400 and detect an indication of the LAN (e.g., an SSID) that is being broadcast by the community playback device 400. The controller device may then transmit a request to connect to the LAN provided by the community playback device 400 and thereby establish a connection with the community playback device 400. In addition to the examples shown above with respect to FIGS. 6-7, this may also include navigating through the MPS controller application to a “Connect to a Community Device” visualization, from which the user may identify the community playback device 400 as being available for connection. Upon identifying the community playback device 400 as being available for connection, the user may then request that a connection be established, for example via the selection of one or more selectable icons that may cause the controller device to transmit a connection request, which may be received by the community playback device 400 at block 504. In response, the community playback device 400 may establish the connection to the user's controller device.

In some implementations, a network device in the community space other than the community playback device 400 (e.g., a router or other network device) may act as an access point to establish a LAN, and the community playback device 400 may connect to the WAN via the LAN established by the network device. In such implementations, the first controller device may also connect to the same LAN and communicate with the community playback device 400 over that LAN. For example, after connecting to the LAN provided by the network device, the user may open the MPS controller application on their controller device and see an indication of the community playback device 400, available for control by the MPS controller application. Other examples are also possible.

As yet another possibility, the community playback device 400 may connect to the first controller device via Bluetooth Low Energy (BLE) communications. For instance, the community playback device 400 may broadcast a BLE beacon that includes information for identifying the community playback device 400 and for establishing a BLE connection with the community playback device 400. The first controller device may detect the BLE beacon that identifies the community playback device 400 and may transmit a responsive BLE message to establish a BLE connection with the community playback device 400. Further details regarding establishing a connection via a BLE signal are included in International Pub. No. WO 2023/039294, entitled “Techniques for Flexible Control of Playback Devices,” which is hereby incorporated by reference in its entirety.

There may be various other possible manners in which the community playback device 400 may connect to the first controller device, some examples of which are described in further detail in U.S. Pat. No. 9,715,365, which is herein incorporated by reference in its entirety.

At block 508, the community playback device 400 may, while connected to the first controller device, (i) continue to transmit the indication that the community playback device 400 is available for connection, (ii) receive, from a second controller device, a second request to connect to the community playback device 400, and (iii) based on the second request, connect to the second controller device. In practice, these operations may be similar to those described with respect to blocks 502-506, but for a second controller device after the community playback device 400 has already established a first connection to the first controller device. As may be appreciated, these operations may further be expanded to contemplate simultaneously connecting the community playback device 400 to multiple controller devices (e.g., as many as are in the community space of the community playback device 400).

Further, although the operations of block 508 are similar to those of blocks 502-506, they need not be identical. For example, at block 502 the community playback device 400 may transmit an indication that the community playback device 400 is available for connection via a WiFi signal, as previously described, and at block 508 the community playback device 400 may additionally or alternatively transmit an indication that the community playback device 400 is available for connection via a BLE signal, as previously described. In this regard, a given controller device might connect to the community playback device 400 in one of several different ways. Further, the community playback device 400 may establish connections to different controller devices using different communication protocols, and such communications may persist simultaneously. Other examples may also exist regarding manners in which the community playback device 400 may receive requests for connection from various controller devices and connect to various controller devices.

At block 510, the community playback device 400 may, while connected to both the first controller device and the second controller device, (i) continue to transmit the indication that the community playback device 400 is available for connection, (ii) receive, from the first controller device, an indication of media content for playback, (iii) retrieve the indicated media content based on the second request, for example, from a streaming media service or from a local audio source as previously described, and (iv) play back the indicated media content.

In practice, the operations of continuing to transmit the indication that the community playback device 400 is available for connection may be similar to the operations described with respect to block 508.

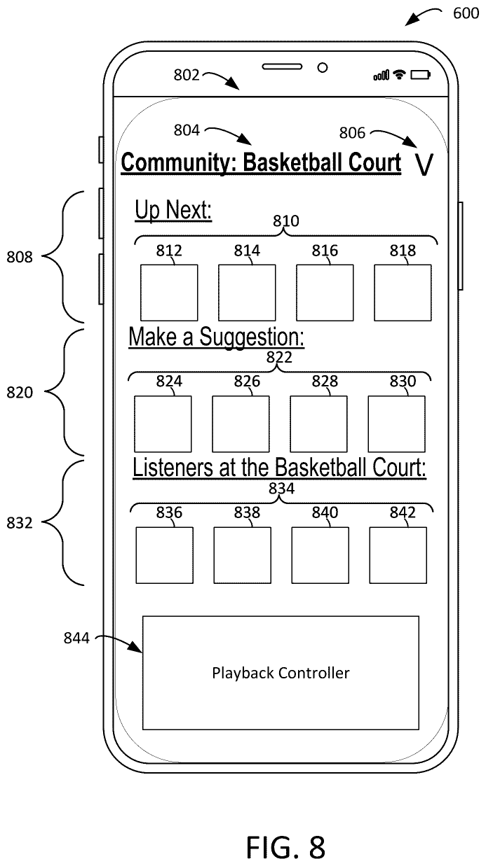

FIG. 8 depicts a diagram of the controller device 600 presenting an example visualization 802 of the MPS controller application that may be presented once the controller device 600 has established a connection to the community playback device 400. The example visualization 802 illustrates various features of the MPS controller application that may enable a user of the controller device 600 to input an indication of media content for playback, which the community playback device 400 may receive as part of the operations at block 510. In practice, the example visualization 802 may enable a user of the controller device 600 to transmit various other playback control commands to the community playback device 400, which may depend on an access level of the user, among various other factors, all of which is described below in greater detail.

As shown, the example visualization 802 may include an indication 804 identifying the community space of the community playback device 400 that the controller device 600 has connected to. As shown, the community space may be a basketball court community space. Various other possible community spaces may also exist.

The example visualization 802 also includes an indicator 806 that may, when selected by a user of the controller device 600, cause the controller device 600 to enable the user to join a different community space. For example, selection of the indicator 806 may cause a visualization such as the example visualization 702 (or possibly 602) to be presented. As another example, selection of the indicator 806 may cause a dropdown menu showing nearby community spaces to be presented as part of the example visualization 802, as well as an availability status of said nearby community spaces (e.g., an indication of whether respective community playback devices of the nearby community spaces are available for connection). Various other examples may also exist.

The example visualization 802 also includes a section 808 showing what media content is being played back by the community playback device 400. As shown, the section 808 is labeled “Up Next,” and includes a visualization 810 of a playback queue that the community playback device 400 may be configured to play back. For example, the community playback device 400 (i) may have previously played back the playback queue (e.g., playback has temporarily been paused), (ii) may currently be playing back the playback queue, and/or (iii) may be scheduled to play back the playback queuc at a future time (e.g., at a scheduled start time of an event that is to occur at the community space). Various other examples may also exist.

As shown, the visualization 810 of the playback queue includes selectable icons 812, 814, 816, and 818, each of which may correspond to a respective media content in the playback queue. Possible results of selecting the selectable icon 812 will now be described, but it should be understood that similar results may also occur based on the selection of any of the selectable icons 812-818.

As one possibility, selection of the selectable icon 812 may cause additional information regarding the media content corresponding to the selectable icon 812 to be presented via the controller device 600, such as metadata regarding (i) a creator (i.e., artist) of the media content, (ii) a duration of the media content, (iii) a title of the media content, (iv) a genre of the media content, and (v) in implementations where the media content has been automatically added to the queue by the community playback device 400, as described in greater detail herein, information describing what factors influenced the community playback device 400 to automatically add the media content, etc.

Additionally or alternatively, the additional information regarding the media content corresponding to the selectable icon 812 may describe statistics of the media content with respect to the community space. For example, the additional information may include metadata regarding (i) an indication of how often the media content is played back by the community playback device 400 in the community space, (ii) a ranking of the media content, for example, based on factors such as (a) how often the media content is added to the playback queue, (b) received input from controller devices in the community space indicating a preference for or against the media content, and (iii) in implementations where a given controller device has requested that the media content be added to the playback queue, an identification of the given controller device (e.g., where a user of the given controller device has given consent for non-identifying information regarding the given controller device, such as a username or handle, to be shared), among various other examples.

As another possibility, selection of the selectable icon 812 may cause the controller device 600 to present selectable icons for controlling playback of the community playback device 400 in certain ways. For example, selection of the selectable icon 812 may cause selectable icons to be presented via the controller device 600 that enable a user of the controller device 600 to (i) rank the media content (e.g., up-vote or down-vote, for instance as part of a democratic voting scheme, as described herein), (ii) “like” or “favorite” the media content, which in some implementations may enable the user of the controller device 600 to recall and play back the media content at a later time, which may be available for users with certain levels of access, as described in greater detail herein, and (iii) submit requests for similar media content to be added to the playback queue, which may be received by the community playback device 400 as described with respect to block 510, among various other examples. In implementations where the media content comprises media content streamed from an internet radio or other content streaming service, user interaction with the selectable icon 812 may serve to influence the type (e.g., genre, among other examples) of media content that is streamed from the internet radio or other content streaming service. Further details are included in U.S. Patent Pub. No. US 2022/0312072, which is herein incorporated by reference in its entirety.

Various other possibilities may also exist.

The example visualization 802 also includes a section 820 for making suggestions for media content, which may be added to the playback queue shown by the visualization 810.

The section 820 includes a set 822 of media content suggestions that may be automatically generated by the community playback device 400. As shown, the set 822 includes selectable icons 824, 826, 828, and 830 for respective media content suggestions generated by the community playback device 400. In practice, the community playback device 400 may generate the media content suggestions based on various factors.

One factor that the community playback device 400 may consider when generating the media content suggestions may be historical information regarding the user of the controller device 600. For example, if the user of the controller device 600 regularly requests that rock music be played, then the community playback device 400 may generate media content suggestions that are influenced by the user of the controller device's preference for rock music.

Another factor that the community playback device 400 may consider when generating the media content suggestions may be the context of the community space. For example, because the community playback device 400 is in a basketball court community space, then the community playback device 400 may suggest upbeat and energetic media content. As another example, if the community playback device 400 were positioned at a recreation center that was scheduled to be used as a wedding reception venue, then the community playback device 400 may suggest popular wedding-themed media content. As yet another example, if the community playback device 400 were positioned at a children's park, then the community playback device 400 may suggest radio versions of media content or the like, such as KidzBop versions of media content (e.g., rather than original, explicit versions of certain media content).

Yet another factor that the community playback device 400 may consider when generating the media content suggestions may be input from a facilitator of the community space wherein the community playback device 400 is positioned. For instance, in some implementations, a facilitator may have the ability to set up, for example, during a setup process of the community playback device 400, a universe of media content from which the community playback device 400 may generate media content suggestions. In practice, the universe of media content may be based on factors such as (i) genres identified by the facilitator, (ii) royalty-free media content, (iii) sponsored media content, and/or (iv) rules excluding certain media content, such as explicit media content, among various other possibilities.

Yet still another factor that the community playback device 400 may consider when generating the media content suggestions may be historical information relating to requests for media content from various controller devices that are currently or were previously in the community space and connected to the community playback device 400. For example, the community playback device 400 may suggest media content that is the same as, or is related to media content that was previously requested by other controller devices, including in instances where previously-requested media content was not available for playback (e.g., in implementations where the community playback device 400 retrieves media content from memory 112b, and where the requested media content was not previously located in memory 112b).

Various other factors may also influence the media content suggestions that are generated by the community playback device 400. Similarly, these factors, as well as other possible factors, may influence other features of the community playback device 400 as well. For instance, based on the determined context of the community space within which the community playback device 400 is positioned, the community playback device 400 may adjust performance settings such as playback volume. As an example, if the community playback device 400 determines that it is positioned in a children's park, and it is evening/night, the community playback device 400 may reduce a maximum volume setting of the community playback device 400, so that controller devices attempting to control the volume at which the community playback device 400 plays back media content are limited by the reduced maximum volume set by the community playback device 400. Further, and as described in greater detail below, these factors, as well as other possible factors, may influence what media content suggestions the community playback device 400 may automatically generate and add to the playback queuc.

In practice, user selection of any of the selectable icons 824-830 may cause the controller device 600, and possibly the community playback device 400, to perform various operations. Various operations that may be performed by the controller device 600 and/or the community playback device 400 based on a user selecting the selectable icon 824 will now be described, but it should be understood that similar operations may also be performed based on the selection of any of the selectable icons 824-830.

As one possibility, user selection of the selectable icon 824 may cause the controller device 600 to present additional selectable icons that may enable the user to provide feedback on the media content of the selectable icon 824, such as upvoting or downvoting the media content corresponding to the selectable icon 824. Such feedback may be communicated to the community playback device 400, which may in turn update the suggested media content in the set 822 based on the provided feedback, as well as possibly any media content automatically added to the playback queue by the community playback device 400. Further details are described in U.S. Pat. Nos. 10,129,599 and 9,478,247, each of which is herein incorporated by reference in its entirety.

As another possibility, user selection of the selectable icon 824 may cause the controller device 600 to transmit an indication of the media content corresponding to the selectable icon 824 to the community playback device 400, which the community playback device 400 may receive as described with respect to block 510.

In practice, the community playback device 400 may perform various operations in response to receiving the indication of the media content corresponding to the selectable icon 824.

As one option, and as described with respect to block 510, the community playback device 400 may begin playing back the media content corresponding to the selectable icon 824 based on receiving the indication of the media content. As another option, the community playback device 400 may add the media content corresponding to the selectable icon 824 to the playback queue based on receiving the indication. As yet another option, in implementations where the user selection of the selectable icon 824 includes an indication that the user wishes to initiate a voting scheme for the media content corresponding to the selectable icon 824, the community playback device 400 may initiate a voting scheme for the media content. In practice, the community playback device 400 may initiate the voting scheme by causing an indication of the media content corresponding to the selectable icon 824 to be presented by various controller devices in the community space that are connected to the community playback device 400. The community playback device 400 may then receive voting results from the various controller devices and determine whether to include the media content corresponding to the selectable icon 824 in the playback queue. Further determinations may include (i) determining where to place the media content within the playback queue, (ii) determining whether to place alternative media content in the playback queue instead of the media content corresponding to the selectable icon 824, and/or (iii) determining whether the voting results will influence the media content suggestions generated by the community playback device 400 and provided to the various controller devices in the community space that are connected to the community playback device 400, among various other possible determinations.

In some implementations the community playback device 400 may receive indications of media content from more than one connected controller device. Accordingly, the community playback device 400 may be configured to intelligently manage the playback queue based on the various indications of media content received from various controller devices.

As one possibility, the community playback device 400 may manage the playback queuc by controlling how much or how often a given controller device may (i) submit indications of media content to be played back by the community playback device 400 or (ii) interact with the community playback device 400 in other ways (e.g., controlling volume, grouping community playback devices, etc.). For instance, when the given controller device is the only controller device connected to the community playback device 400, then the given controller device may transmit an unrestricted number of indications to the community playback device 400 for playback. However, when more than one controller device connects to the community playback device 400, the community playback device 400 may impose limits on the number of media content indications each controller device may submit for playback by the community playback device 400.

In practice, the community playback device 400 may impose said limits by monitoring the number of indications of media content for playback by the community playback device 400 received from each controller device in the community space that is connected to the community playback device 400. Then, after receiving a threshold number of indications of media content for playback from a given controller device, the community playback device 400 may cause the given controller device to disable sending new indications of media content for playback for a given period of time. As one example, the threshold number of indications of media content may be, for example, three indications, and the period of time may be a static period of time, such as five minutes, ten minutes, etc.

As another example, the period of time may be a relative period of time, such as a period of time based on the level of interaction from other controller devices that are connected to the community playback device 400. For instance, the period of time may extend until another controller device that is connected to the community playback device 400 sends an indication of media content for playback. Further, if there is little interaction from other controller devices that are connected to the community playback device 400, then the period of time may adjust accordingly (e.g., if the given controller device is the only controller device that is actively interacting with the community playback device 400, then the given controller device 400 may not be restricted until another controller device in the community space sends an indication of media content for playback.) Additionally and/or alternatively, a user of another controller device in the community space may indicate that they intend to send indications of media content for playback by the community playback device 400 (e.g., by establishing a connection to the community playback device 400), which may adjust the period of time before another controller device may submit another indication of media content. Various other examples may also exist.

The community playback device 400 may also manage the playback queue by controlling how much or how often a given controller device may (i) submit indications of media content to be played back by the community playback device 400 or (ii) interact with the community playback device 400 in other ways, by implementing a “reservation” queue. For instance, controller devices may submit requests to reserve or otherwise schedule a period of time to have exclusive, uninterrupted control of the community playback device 400. In practice, this may involve a facilitator of the community playback device reviewing and approving such requests and perhaps maintaining schedules of the community playback device 400. Various other examples may also exist.

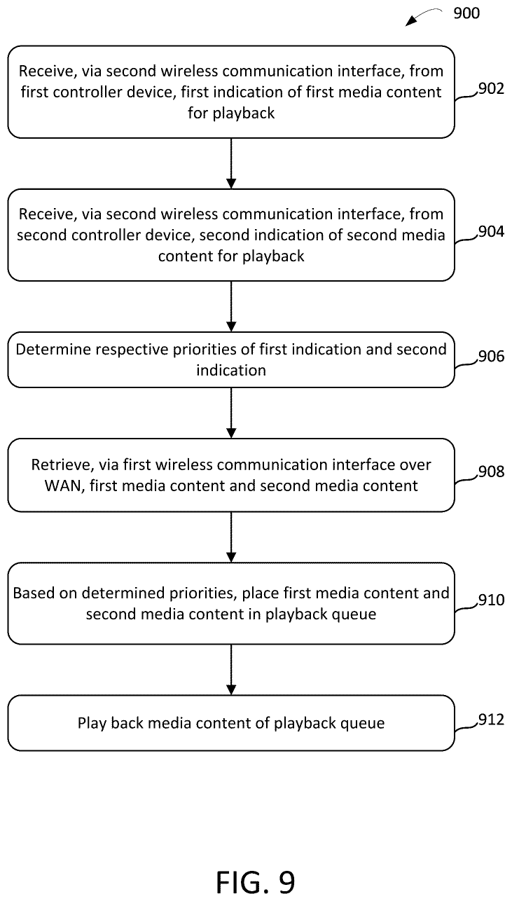

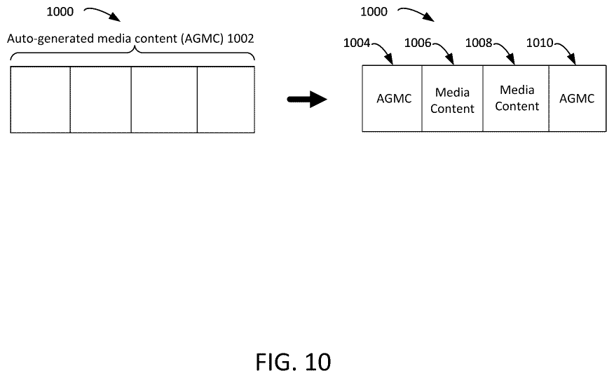

As another possibility, the community playback device 400 may manage the playback queue by implementing a prioritization scheme for indications of media content received by the community playback device 400. In practice, there may be various prioritization schemes that the community playback device 400 may implement to manage the playback queue, examples including (i) a first-in-first-out (FIFO) prioritization scheme, wherein media content is added to the playback queue in the order that the community playback device 400 receives indications of the media content, (ii) a democratic prioritization scheme, wherein the order in which media content is placed within the playback queue is determined based on voting results from one or more controller devices that are connected to the community playback device 400, similar to the voting scheme previously described, (iii) a relatedness prioritization scheme, wherein the order in which media content is placed within the playback queue is determined based on how related media content is to a determined theme of the community space (e.g., meditative media content may have a priority higher than rock media content if the determined theme is a yoga class), and/or (iv) a tiered-account-access prioritization scheme, wherein the order in which respective media content is placed within the playback queue is determined based on a tiered access level of a respective controller device that requested the media content, among various other examples. Further, in some implementations, the community playback device 400 may implement more than one of the described prioritization schemes together to manage the playback queue. FIGS. 9-10 provide further detail below regarding manners by which the community playback device 400 may implement prioritization schemes to manage the playback queuc.

Further examples of providing and managing collaborative interactions with social playback queue are included in U.S. Pub. No. US 2015/0356084, entitled “Social Queue,” which is herein incorporated by reference in its entirety.

As noted above, a user account associated with the MPS controller application may not be required for a user (e.g., a visitor to the community space) to engage in any of the community playback experiences discussed herein. Rather, a controller device installed with the MPS controller application may be all that is needed to access and control a community playback device. However, account creation may also be possible, with various benefits that will be discussed further below.

In practice, user accounts of the MPS controller application may be assigned one of various tiers of access, based on various factors. One tier of access may be designated for facilitators of the community playback device 400. Another tier of access may be designated for users with a paid account associated with the MPS controller application. Yet another tier of access may be designated for users without a paid account associated with the MPS controller application (i.e., users with a free version of the MPS controller application). Still further tiers of access may be awarded to users based on their participation in the community playback experience. For example, user accounts may be awarded points and “leveled-up” based on (i) connecting a control device to community playback devices in various community spaces (e.g., an initial amount of points for each new community playback device, as well as a lesser amount of points for subsequent connections to known community playback devices), (ii) participating in voting schemes for media content potentially being added to community playback queues (e.g., either by suggesting the media content to be voted on or by voting for media content suggested by other users or possibly generated by the community playback device 400), and/or (iii) sending indications of media content for playback by the community playback device 400, among various other examples. Various other tiers may also exist.

In practice, the tiers of access may provide various additional benefits to users in addition to those that may be realized via the prioritization scheme. As one example, accounts with higher tiers of access (e.g., a paid account associated with the MPS controller application, a leveled-up account associated with the MPS controller application, a facilitator account of the MPS controller application, etc.) may be able to submit more indications of media content to be played back by the community playback device 400 than lower tiers of access. For instance, a level 1 account of the MPS controller application may be able submit one indication of media content every 5 minutes when there is more than one controller device connected to the community playback device 400, whereas a level 5 account of the MPS controller application may be able to submit more than one indication of media content every 5 minutes.

As another example, accounts with higher tiers of access may be able to search for media content to add to the playback queue. For instance, the section 820 shown in the visualization 802 of the MPS controller application of FIG. 8 may additionally include a selectable icon (not shown) that enables users to search for certain media content to add to the playback queue, for example, beyond the suggested media content of the set 822. In some implementations, this selectable icon may only be presented (or alternatively, may only be selectable) for higher tiered accounts.

In some implementations, a control device may include a microphone configured to capture voice commands related to requested media content, which may be processed by the controller device or transmitted to the community playback device 400 for processing. In this regard, the controller device, community playback device 400, and/or other device(s) connected to the community playback device 400 may function as a gateway between one or more voice assistant services and the various media content services that may be accessible by the community playback device 400, such that a media content request made via a voice command is not limited to being retrieved from any one content service. Further details in this regard can be found in U.S. Pub. No. 2020/0110571, entitled “Systems and Methods for Media Content Selection” which is herein incorporated by reference in its entirety.

As yet another example, accounts with higher tiers of access may be able to submit requests for streamed media content, e.g., from a streaming media service, whereas lower-tiered accounts may only be able to submit requests for media content stored locally, for example, at the community playback device 400. Further, in some implementations, lower-tiered accounts (e.g., free accounts) may be limited to submitting requests for media content suggested by the community playback device 400, for example via selection of one of the selectable icons 824-830 of the set 822.

As still yet another example, accounts with higher tiers of access may be able to store favorite media content for later playback. For instance, a user with a higher tier of access may “favorite” certain media content to store and play back at a later time. In some implementations, this may involve a user with a higher tier of access searching through a history of media content that has previously been played back at a given community space for playback to select certain media content for storage for future playback. As one example, this may include a history of media content that was played back at the given community space while the user was at the given community space (e.g., a controller device of the user was connected to a community playback device of the given community space). As another example, this may include a history of media content that was played back at the given community space regardless of whether the user was at the given community space. Various other examples may also exist.

As yet another example, accounts with higher tiers of access may be able to assemble a playlist, prior to connecting to a community playback device, and then request that the playlist be added to the playback queue once the controller device associated with the account is connected to the community playback device. Conversely, accounts with lower tiers of access may only be able to request that individual songs be added to be playback queue. In practice, the playlist added to the playback queue may be added as media content that cannot be separated, or may alternatively be separated into discrete media content items, each of which with a respectively assigned priority. As may be appreciated, this may result in the added playlist being “broken up” by other media content added to the queue.

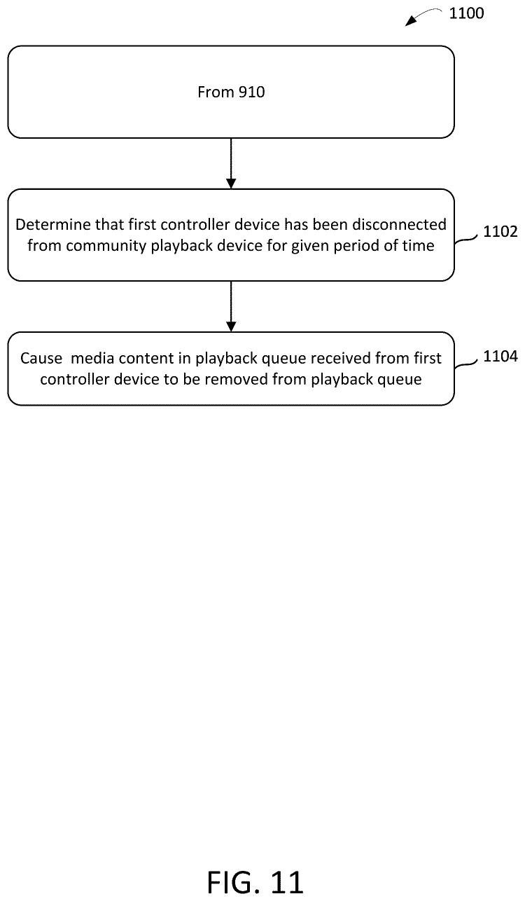

As still yet another example, accounts with higher tiers of access may be able to disconnect from the community playback device 400 for a longer period of time than accounts with lower tiers of access before the community playback device 400 removes media content from the playback queue. Further details regarding the removal of media content from playback queues, as well as the removal of other influences that interactions of controller devices with the community playback device 400 may have on the community media playback experience are described in greater detail below with respect to FIGS. 11-13.

As yet another example, points earned via participation in a community media playback experience may be redeemable for certain perks or rewards. For instance, certain discount codes may be unlocked by attaining various account levels. These discount codes may be for Sonos products, as well as for local products, e.g., products that may be relevant to the community spaces visited in the process of leveling up the account associated with the MPS controller application. (e.g., leveling up in a basketball court community space may unlock discount codes for tickets to an upcoming basketball game, discount codes for basketball-related products, etc.).

As still yet another example, accounts with higher tiers of access may be able to link to the community playback device 400 to upload some or all of the user preferences associated with said accounts. In practice, a user of a higher tiered account may opt out of having certain (e.g., identifying) information being communicated to the community playback device 400 via the link. Further details are included in U.S. Pat. No. 10,698,650, which is herein incorporated by reference in its entirety.

Various other examples may also exist.

As yet another possibility, the community playback device 400 may manage the playback queue by adding media content determined by the community playback device 400 to the playback queue. In practice, the community playback device 400 may determine the media content to be added to the queue based on any of the factors previously described with respect to the manners in which the community playback device 400 generates media content suggestions, among various other possibilities. The media content determined by the community playback device 400 may generally have a lower priority than media content requested by controller devices, although the community playback device 400 may determine the priority for media content generated by the community playback device 400 by implementing one or more prioritization schemes previously described.

As yet another possibility, the community playback device 400 may manage the playback queue by adding generative media content created by the community playback device 400 or a similar device. Further details regarding the creation and playback of generative media content are included in International Pub. No. WO 2022/109556, which is herein incorporated by reference in its entirety.

As still yet another possibility, the community playback device 400 may manage the playback queue by refusing to add media content requested by controller devices that are connected to the community playback device 400, in some situations. As one example, the community playback device 400 may refuse to add media content to the playback queue that has been restricted by a facilitator of the community space. In practice, certain media content may be restricted broadly (e.g., globally, at all times) or narrowly (e.g., at certain community spaces, at certain times, etc.). As another example, the community playback device 400 may refuse to add media content to the playback queue that does not fit into a determined theme of the community space. For instance, if the community playback device 400 determines that the context of the community space, at a given time, is a community yoga class at a recreation center, then the community playback device 400 may refuse to add media content to the playback queue that may be disruptive to the community yoga class (e.g., rock music). The community playback device 400 may refuse to add media content to the playback queue for various other reasons as well.

As yet another possibility, the community playback device 400 may manage the playback queue by removing media content from the playback queue that was added by controller devices that have disconnected from the community playback device 400. These features are described in further detail with respect to FIGS. 11-13 below. Additionally, further details regarding resetting a media playback system are included in U.S. Pat. No. 10,042,602, which is herein incorporated by reference in its entirety.

The community playback device 400 may manage the playback queue in various other ways as well.

Returning to FIG. 8, the example visualization 802 may also include a section 832 for identifying and possibly interacting with other listeners in the community space that are connected to the community playback device 400. As shown, the section 832 includes a list 834 of one or more nearby listeners, including selectable icons 836, 838, 840, and 842, each of which represents a respective nearby user of a controller device that is connected to the community playback device 400. In practice, users may opt into this feature, and users who have not opted into this feature may not be represented by a selectable icon in the list 834.

The MPS controller application may provide various functionality regarding the nearby users of controller devices in the community space that are connected to the community playback device 400. Various operations that may be performed by the controller device 600 based on a user selecting the selectable icon 836 will now be described, but it should be understood that similar operations may also be performed based on the selection of any of the selectable icons 836-842. As one possibility, selection of the selectable icon 836 may cause information related to the user represented by the selectable icon 836 to be presented. Such information may include (i) a username or other handle for the user, (ii) a list of media content recently added to the playback queue by the user, and (iii) statistics indicating the user's level, activity (e.g., how may upvotes or downvotes on media content they have added to the playback queue), popularity (e.g., how may upvotes or downvotes their media content suggestions have received), etc., among various other examples. As another possibility, selection of the selectable icon 836 may enable a user to communicate with the user represented by the selectable icon 836, such as by sending chat messages or the like to the user's account. Various other possibilities may also exist.

The example visualization 802 also includes a playback control section 844 that facilitates various control features that the controller device 600 may have access to. With reference to the example media playback controls shown in FIG. 1I, the playback control features in playback control section 844 may include (i) volume control, (ii) grouping control, for example, in implementations where there are multiple community playback devices in the community space, and possibly (iii) playback control (e.g., play, pause, skip, rewind, fast-forward, etc.), among various other possibilities.

To provide for a functional community playback experience, the community playback device 400 may limit user access to certain of the control features in various ways. As one example, a user's access to the features of the control section 844 may be determined based on what tier of access they have. For instance, only a facilitator may have access to some or all of the features of the control section 844.

As another example, the community playback device 400 may facilitate control decisions being made via a democratic voting scheme, in a manner similar to the examples above. For instance, a first user may suggest a first volume setting for the community playback device 400, whereas a second user may suggest a second volume setting for the community playback device 400. Users of controller devices in the community space that are connected to the community playback device 400 may then vote for one of the volume settings, and the community playback device 400 may play back media content at a volume based on the results of the voting scheme. As may be appreciated, similar voting schemes may be used for other control features as well.

As yet another example, the community playback device 400 may facilitate the controller devices in the community space taking turns having access to control features of the playback control section 844. For instance, a first controller device may have access to one or more of the control features of the playback control section 844 for a first period of time, and then access to one or more of the control features of the playback control section 844 may be passed to a second controller device, and so forth. Various other examples may also exist.

FIG. 9 shows an example flowchart 900 illustrating various operations that may be carried out by the community playback device 400 to implement one or more prioritization strategies to manage a playback queue, in accordance with the present disclosure.

Beginning at block 902, the community playback device 400 may receive, via the second wireless communication interface 404, from a first controller device, a first indication of first media content for playback. In practice, this may be similar to operations of block 510 of FIG. 5.

At block 904, the community playback device 400 may receive, via the second wireless communication interface 404, from a second controller device, a second indication of second media content for playback. In practice, this may be similar to operations of block 902, but for a second controller device that may be simultaneously connected to the community playback device 400.

At block 906, the community playback device 400 may determine respective priorities of the first indication of first media content and the second indication of second media content. For instance, the community playback device 400 may be configured to implement one or more prioritization schemes as previously described. To illustrate with an example, the community playback device 400 may determine (i) that a user who sent the first indication of first media content has a free version of the MPS controller application, and (ii) that a second user who sent the second indication of the second media content has a paid version of the MPS controller application. Accordingly, the community playback device 400 may determine that the second indication of the second media content has a higher priority than the first indication of the first media content, despite having possibly received the first indication of the first media content possibly before the second indication of the second media content.

At block 908, the community playback device 400 may retrieve the first media content and the second media content. As one possibility, the community playback device 400 may retrieve the first media content and/or the second media content from an external audio source, such as a streaming media service, as previously described. In practice, the community playback device 400 may utilize the first wireless communication interface 402 to retrieve said media content via the WAN. As another possibility, the community playback device 400 may retrieve the first media content and/or the second media content from memory of the community playback device 400 or a local audio source, such as the local audio source 150, as previously described.

At block 910, the community playback device 400 may, based on the determined priorities for the first indication of first media content and the second indication of second media content, place the first media content and the second media content in a playback queuc. Continuing the example discussed above with respect to block 906, this may involve the community playback device 400 placing the second media content at a first position in the playback queue and the first media content at a second position in the playback queue that is after the first position.

As may be appreciated, the playback queue may include various other media content in addition to the first media content and the second media content, such as (i) media content requested by other controller devices that are connected to the community playback device 400, along with (ii) media content determined by the community playback device 400. Accordingly, the order of media content in the playback queue may be determined based on the priority of each media content in the playback queuc.

At block 912, the community playback device 400 may play back the media content in the playback queue.

FIG. 10 depicts a playback queue 1000 that may be managed by the community playback device 400, for example, based on received indications of media content from one or more controller devices.

At a first point in time, e.g., before receiving any indications of media content, the playback queue may include auto-generated media content (AGMC) 1002 comprising various media items that the community playback device 400 may have determined and added to the playback queue 1000. As previously described, the AGMC 1002 may be determined by the community playback device 400 based on any of various factors. Later, the community playback device 400 may receive (i) a first indication of first media content and (ii) a second indication of second media content, as previously described with respect to blocks 902-904 of FIG. 9.

The community playback device 400 may then update the playback queue 1000 based on the received indications of media content. As shown, the community playback device 400 may update the playback queue 1000 to include (i) a first media item comprising AGMC 1004, (ii) a second media item comprising media content 1006, (iii) a third media item comprising media content 1008, and (iv) a fourth media item comprising AGMC 1010.

The AGMC 1004 may be media content that was included in the AGMC 1002 or may be different AGMC. As another example, the AGMC 1004 may include media content that is similar to the media content of the AGMC 1002.

Further, the media content 1006 and the media content 1008 may respectively be (i) the first media content and the second media content, or (ii) the second media content and the first content, depending on how the community playback device is configured to manage the playback queue 1000. As one example, the community playback device 400 may be configured to manage the playback queue 1000 based on a FIFO prioritization scheme, in which case the community playback device 400 may prioritize the first media content over the second media content. Accordingly, in such an example the media content 1006 may be the first media content, and the media content 1008 may be the second media content 1008. As another example, the community playback device 400 may be configured to manage the playback queue 1000 based on a tiered-account-access prioritization scheme, in which case the community playback device 400 may prioritize the second media content over the first media content, for instance, if a user of the second controller device has a higher tiered account than a user of the first controller device. Various other examples may exist.

The AGMC 1010 may be determined based on various factors, as previously described. As one possibility, the AGMC 1010 may be related to the AGMC 1004. For instance, the AGMC 1004 and the AGMC 1010 may both be AGMC that was included in the AGMC 1002. The AGMC 1010 may also be related to AGMC 1004 in other manners as well (e.g., the AGMC 1010 may be media content of a same genre as that of the AGMC 1004).

As another possibility, the AGMC 1010 may be determined based on the media content 1006 and 1008. For example, if the media content 1006 and the media content 1008 are both media content of a given genre (e.g., pop), a given artist (e.g., Taylor Swift), etc., then the community playback device 400 may determine the AGMC 1010 to include media content of the same or a similar genre/artist/etc.

As yet another possibility, the AGMC 1010 may be determined based on the determined context of the community space wherein the community playback device 400 is positioned, as previously described. Various other possibilities may also exist, and in practice, the AGMC 1010 may be generated according to a combination of some or all of the possibilities described, rather than a single enumerated possibility.

As previously described, one manner in which the community playback device 400 may manage the playback queue is by removing media content from the queue that was added by a controller device that disconnects from the community playback device 400. Accordingly, FIG. 11 shows an example flowchart 1100 illustrating various operations that may be carried out by the community playback device 400 to manage a playback queue by removing media content that was added by a disconnected controller device.

As shown, the flowchart 1100 may pick up from block 910 of FIG. 9.

At block 1102, the community playback device 400 may determine that the first controller device has been disconnected from the community playback device 400 for a given period of time. As one example, the given period of time may be instantaneous, such that the community playback device 400 may determine that the first controller device has been disconnected from the community playback device for the given period of time as soon as the first controller device is disconnected. As another example, the given period of time may be longer, such as 5 minutes, 10 minutes, 1 hour, etc., and the community playback device 400 may determine that the first controller device has been disconnected from the community playback device for the given period of time after the threshold period of time has passed. As yet another example, the period of time may depend on the tier of access of a user account associated with the first controller device. For instance, a first tier of access may be associated with a first period of time, and a second, higher tier of access may be associated with a second, longer, period of time, etc. For instance, if the user of the first controller device is a facilitator of the community space, then media content added to the queue by the first controller device may not be removed despite the first controller device having been disconnected from the community playback device 400 for an extended period of time.

At block 1104, based on determining that the first controller device has been disconnected for the given period of time, the community playback device 400 may cause media content in the playback queue that was added by the first controller device to be removed from the playback queue.

The community playback device 400 may analyze metadata that identifies the sources of media content added to the playback queue to determine which media content of the playback queue, if any, was added to the playback queue based on indications of media content from the first controller device.

Once identified, any media content added to the playback queue based on indications from the first controller may then be removed. However, in some implementations, media content may remain in the playback queue despite the first controller device disconnecting from the community playback device 400 for the given period of time. For instance, if media content added based on indications of media content from the first controller device was added to the playback queue by way of a voting scheme, as previously described, and the media content received positive votes from various other controller devices in the community space connected to the community playback device 400, then the community playback device 400 may not remove the media content. As may be appreciated, media content may remain in the playback queue for various other reasons as well.

Further, in some implementations the community playback device 400 may be configured to remove and/or adjust more than just the media content that was requested by the first controller device, such as an influence of interactions of the first controller device with the community playback device 400, such as via the example visualization 802 described with respect to FIG. 8. In line with the discussion above, there may be various influences that interactions of the first controller device may have on various aspects of the community media playback experience, such as based on participating in voting schemes for media content that may have been (i) suggested by the community playback device 400 or (ii) submitted for addition to the playback queue from other playback devices. Accordingly, the community playback device 400 may be configured to recalibrate various determinations concerning the community media playback experience based on the first controller device disconnecting from the community playback device 400 for the given amount of time, such as (i) determining what media content to suggest for playback and (ii) determining what media content is automatically generated and added to the playback queue, as previously described with respect to FIG. 8, among various other options. Beneficially, this may serve to recalibrate the musical preferences that are currently influencing the community playback experiences, by removing the influence of the departed user's interactions and by extension, increasing the relative influence of any users whose controller devices are still connected to the community playback device 400.

As one possibility, the community playback device 400 may recalibrate the various determinations at once, so that the interactions of the first controller device with the community playback device 400 no longer has any influence on the community media playback experience. As another possibility, the community playback device 400 may recalibrate the various determinations over a period of time. For example, some influences of the interactions of the first controller device with the community playback device 400 may be removed immediately, whereas other influences of the interactions of the first controller device with the community playback device 400 may be removed over a period of time.

Further, in some implementations, the community playback device 400 may restore an influence of the first controller device upon the first controller device reconnecting to the community playback device 400. As may be appreciated, the extent of influence that may be restored may have a diminishing effect. For example, every month (or other period of time) of inactivity may result in a step down in the extent of influence that may be restored. It may also be possible for levels of the MPS controller application to be diminished in a similar fashion. For example, every month (or other period of time) of inactivity may result in a user's account associated with the MPS controller application being demoted by some amount (e.g., one level). Various other possibilities may also exist.

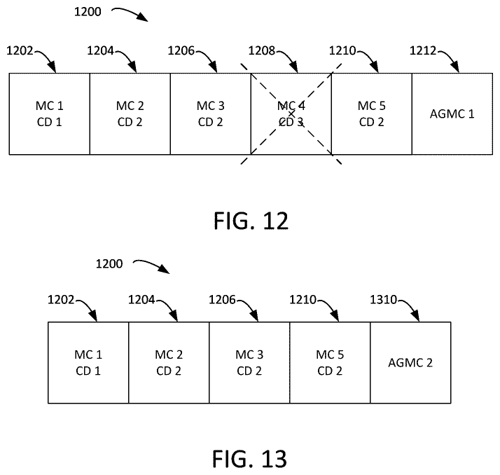

FIGS. 12-13 provide an illustrative example of the operations of the flowchart 1100. Beginning with FIG. 12, a playback queue 1200 is shown including media content from various sources. As shown, the playback queue 1200 includes (i) a first media item comprising media content 1202 that was added by a first controller device (CD 1), (ii) a second media item comprising media content 1204 that was added by a second controller device (CD 2), (iii) a third media item comprising media content 1206 that was added by the second controller device (e.g., after waiting for a period of time to be enabled to again add media content to the playback queue 1200), (iv) a fourth media item comprising media content 1208 that was added by a third controller device (CD 3), (v) a fifth media item comprising media content 1210 that was added by the second controller device (e.g., after again waiting for a period of time to be enabled to again add media content to the playback queue 1200), and (vi) a sixth media item comprising AGMC 1212, which may have been determined by the community playback device 400 based on any of various factors, as previously described.

As shown, the media content 1208 may be removed from the playback queue 1200 by the community playback device 400, for instance, based on the community playback device 400 determining that the third controller device has disconnected from the community playback device 400 for a given period of time, as described above with respect to FIG. 11.

FIG. 13 then shows the playback queue 1200 after being updated by the community playback device 400 based on the media content 1208 being removed. As shown, the playback queue 1200 includes (i) the first media item comprising media content 1202 that was added by the first controller device, (ii) the second media item comprising media content 1204 that was added by the second controller device, (iii) the third media item comprising media content 1206 that was added by the second controller device, (iv) the fifth media item comprising media content 1210 that was added by the second controller device, and (v) a sixth media item comprising AGMC 1310, which may have been generated by the community playback device 400 based on any of various factors.

As previously described, in some implementations the community playback device 400 may be configured to remove an influence that the media content 1208 may have had on various aspects of the community media playback experience. Accordingly, the AGMC 1310 may be different from the AGMC 1212, based on the third controller device disconnecting from the community playback device 400 for the given period of time. As one example, the community playback device 400 may have been influenced by the media content 1208 or other interactions of the third controller device with the community playback device 400 in determining the AGMC 1212. Accordingly, when the media content 1208 and the interactions of the third controller device are removed, the community playback device 400 may determine different media content following the media content 1210, as represented by the AGMC 1310. Various other examples may also exist.

FIGS. 5, 9, and 11 include one or more operations, functions, or actions as illustrated by one or more operational blocks. Although the blocks are illustrated in a given order, some of the blocks may also be performed in parallel, and/or in a different order than those described herein. Also, the various blocks may be combined into fewer blocks, divided into additional blocks, and/or removed based upon the desired implementation.

In addition, for the flowcharts 500, 900, and 1100 shown in FIGS. 5, 9, and 11, respectively, and other processes and methods disclosed herein, the diagrams show functionality and operation of one possible implementation of present embodiments. In this regard, each block may represent a module, a segment, or a portion of program code, which includes one or more instructions executable by one or more processors for implementing logical functions or blocks in the process.

The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long-term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the processes and methods disclosed herein, each block in FIGS. 4 and 6A may represent circuitry and/or machinery that is wired or arranged to perform the specific functions in the process.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

Further, the examples described herein may be employed in systems separate and apart from media playback systems such as any Internet of Things (IOT) system comprising an IoT device. An IoT device may be, for example, a device designed to perform one or more specific tasks (e.g., making coffee, reheating food, locking a door, providing power to another device, playing music) based on information received via a network (e.g., a WAN such as the Internet). Example IoT devices include a smart thermostat, a smart doorbell, a smart lock (e.g., a smart door lock), a smart outlet, a smart light, a smart vacuum, a smart camera, a smart television, a smart kitchen appliance (e.g., a smart oven, a smart coffee maker, a smart microwave, and a smart refrigerator), a smart home fixture (e.g., a smart faucet, a smart showerhead, smart blinds, and a smart toilet), and a smart speaker (including the network accessible and/or voice-enabled playback devices described above). These IoT systems may also comprise one or more devices that communicate with the IoT device via one or more networks such as one or more cloud servers (e.g., that communicate with the IoT device over a WAN) and/or one or more control devices (e.g., that communicate with the IoT device over a LAN and/or a PAN). Thus, the examples described herein are not limited to media playback systems.

It should be appreciated that references to transmitting information to particular components, devices, and/or systems herein should be understood to include transmitting information (e.g., messages, requests, responses) indirectly or directly to the particular components, devices, and/or systems. Thus, the information being transmitted to the particular components, devices, and/or systems may pass through any number of intermediary components, devices, and/or systems prior to reaching its destination. For example, a control device may transmit information to a playback device by first transmitting the information to a computing system that, in turn, transmits the information to the playback device. Further, modifications may be made to the information by the intermediary components, devices, and/or systems. For example, intermediary components, devices, and/or systems may modify a portion of the information, reformat the information, and/or incorporate additional information.

Similarly, references to receiving information from particular components, devices, and/or systems herein should be understood to include receiving information (e.g., messages, requests, responses) indirectly or directly from the particular components, devices, and/or systems. Thus, the information being received from the particular components, devices, and/or systems may pass through any number of intermediary components, devices, and/or systems prior to being received. For example, a control device may receive information from a playback device indirectly by receiving information from a cloud server that originated from the playback device. Further, modifications may be made to the information by the intermediary components, devices, and/or systems. For example, intermediary components, devices, and/or systems may modify a portion of the information, reformat the information, and/or incorporate additional information.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A playback device comprising:
at least one processor;
a first wireless communication interface for communicating over a wide area network (WAN);
a second wireless communication interface for communicating with at least one of controller devices or playback devices;
non-transitory computer-readable medium; and
program instructions stored on the non-transitory computer-readable medium that are executable by the at least one processor such that the playback device is configured to:
transmit, via the second wireless communication interface, an indication that the playback device is available for connection;
receive, via the second wireless communication interface, from a first controller device that is installed with an application for controlling the playback device, a first request to connect to the playback device;
based on the first request, connect to the first controller device via the second wireless communication interface;
while connected to first controller device:
continue to transmit, via the second wireless communication interface, the indication that the playback device is available for connection;
receive, via the second wireless communication interface, from a second controller device that is installed with the application for controlling the playback device, a second request to connect to the playback device; and
based on the second request, connect to the second controller device via the second wireless communication interface; and
while connected to both the first controller device and the second controller device:
continue to transmit, via the second wireless communication interface, the indication that the playback device is available for connection;
receive, via the second wireless communication interface, from the first controller device, an indication of media content for playback;
retrieve, via the first wireless communication interface over the WAN, the indicated media content; and
play back the indicated media content.

2. The playback device of claim 1, wherein the first wireless communication interface is capable of communication over one or more of 3G, 4G, or 5G cellular networks.

3. The playback device of claim 1, wherein the program instructions that are executable by the at least one processor such that the playback device is configured to transmit, via the second wireless communication interface, the indication that the playback device is available for connection comprise program instructions that are executable by the at least one processor such that the playback device is configured to transmit an 802.11 message indicating that the playback device is available for connection.

4. The playback device of claim 1, wherein the program instructions that are executable by the at least one processor such that the playback device is configured to transmit, via the second wireless communication interface, the indication that the playback device is available for connection comprise program instructions that are executable by the at least one processor such that the playback device is configured to transmit a Bluetooth beacon indicating that the playback device is available for connection.

5. The playback device of claim 1, wherein the media content is first media content, further comprising program instructions stored on the non-transitory computer-readable medium that are executable by the at least one processor such that the playback device is configured to:
receive, via the second wireless communication interface, from the second controller device, an indication of second media content for playback;
retrieve, via the first wireless communication interface over the WAN, the indicated second media content; and
play back the indicated second media content.

6. The playback device of claim 5, further comprising program instructions stored on the non-transitory computer-readable medium that are executable by the at least one processor such that the playback device is configured to determine that a priority of the indication of the second media content is higher than a priority of the indication of the first media content; and
wherein the program instructions that are executable by the at least one processor such that the playback device is configured to play back the indicated second media content comprise program instructions that are executable by the at least one processor such that the playback device is configured to, based on determining that the priority of the indication of the second media content is higher than the priority of the indication of the first media content, play back the indicated second media content before playing back the indicated first media content.

7. The playback device of claim 1, further comprising program instructions stored on the non-transitory computer-readable medium that are executable by the at least one processor such that the playback device is configured to, after receiving a threshold number of indications of media content for playback from a given controller device, cause the given controller device to not be capable of sending new indications of media content for playback for a given period of time.

8. The playback device of claim 1, wherein the playback device is a first playback device, further comprising program instructions stored on the non-transitory computer-readable medium that are executable by the at least one processor such that the first playback device is configured to:
establish, via the second communication interface, a connection with a second playback device;
receive, via the second wireless communication interface, from the first controller device or the second controller device, an indication of a command to form a group with the second playback device for synchronous playback of media content; and
based on the indication of the command, form the group with the second playback device for synchronous playback of media content.

9. The playback device of claim 8, wherein the program instructions that are executable by the at least one processor such that the first playback device is configured to play back the indicated media content comprise program instructions that are executable by the at least one processor such that the first playback device is configured to play back the indicated media content in synchrony with the second playback device.

10. The playback device of claim 1, further comprising program instructions stored on the non-transitory computer-readable medium that are executable by the at least one processor such that the playback device is configured to:
before playing back the indicated media content, add the indication of the media content to a playback queue for playback by the playback device.

11. The playback device of claim 10, further comprising program instructions stored on the non-transitory computer-readable medium that are executable by the at least one processor such that the playback device is configured to:
determine that the first controller device has been disconnected from the playback device for a given period of time; and
based on determining that the first controller device has been disconnected from the playback device for the given period of time, cause any indications of media content in the playback queue that were received from the first controller device to be removed from the playback queue.

12. The playback device of claim 1, wherein the indication of media content is a uniform resource identifier (URI) or a uniform resource locator (URL).

13. A non-transitory computer-readable medium, wherein the non-transitory computer-readable medium is provisioned with program instructions that, when executed by at least one processor, cause a playback device that comprises (i) a first wireless communication interface for communicating over a wide area network (WAN) and (ii) a second wireless communication interface for communicating with at least one of controller devices or playback devices to:
transmit, via the second wireless communication interface, an indication that the playback device is available for connection;
receive, via the second wireless communication interface, from a first controller device that is installed with an application for controlling the playback device, a first request to connect to the playback device;
based on the first request, connect to the first controller device via the second wireless communication interface;
while connected to first controller device:
continue to transmit, via the second wireless communication interface, the indication that the playback device is available for connection;
receive, via the second wireless communication interface, from a second controller device that is installed with the application for controlling the playback device, a second request to connect to the playback device; and
based on the second request, connect to the second controller device via the second wireless communication interface; and
while connected to both the first controller device and the second controller device:
continue to transmit, via the second wireless communication interface, the indication that the playback device is available for connection;
receive, via the second wireless communication interface, from the first controller device, an indication of media content for playback;
retrieve, via the first wireless communication interface over the WAN, the indicated media content; and
play back the indicated media content.

14. The non-transitory computer-readable medium of claim 13, wherein the first wireless communication interface is capable of communication over one or more of 3G, 4G, or 5G cellular networks.

15. The non-transitory computer-readable medium of claim 13, wherein the program instructions that, when executed by at least one processor, cause the playback device to transmit, via the second wireless communication interface, the indication that the playback device is available for connection comprise program instructions that, when executed by at least one processor, cause the playback device to transmit an 802.11 message indicating that the playback device is available for connection.

16. The non-transitory computer-readable medium of claim 13, wherein the program instructions that are executable by the at least one processor such that the playback device is configured to transmit, via the second wireless communication interface, the indication that the playback device is available for connection comprise program instructions that, when executed by at least one processor, cause the playback device to transmit a Bluetooth beacon indicating that the playback device is available for connection.

17. The non-transitory computer-readable medium of claim 13, wherein the media content is first media content, and wherein the non-transitory computer-readable medium is provisioned with program instructions that, when executed by at least one processor, cause the playback device to:
receive, via the second wireless communication interface, from the second controller device, an indication of second media content for playback;
retrieve, via the first wireless communication interface over the WAN, the indicated second media content; and
play back the indicated second media content.

18. The non-transitory computer-readable medium of claim 17, wherein the non-transitory computer-readable medium is provisioned with program instructions that, when executed by at least one processor, cause the playback device to determine that a priority of the indication of the second media content is higher than a priority of the indication of the first media content; and
wherein the program instructions that, when executed by at least one processor, cause the playback device to play back the indicated second media content comprise program instructions that, when executed by at least one processor, cause the playback device to, based on determining that the priority of the indication of the second media content is higher than the priority of the indication of the first media content, play back the indicated second media content before playing back the indicated first media content.

19. The non-transitory computer-readable medium of claim 13, wherein the non-transitory computer-readable medium is provisioned with program instructions that, when executed by at least one processor, cause the playback device to, after receiving a threshold number of indications of media content for playback from a given controller device, cause the given controller device to not be capable of sending new indications of media content for playback for a given period of time.

20. A method carried out by a playback device that comprises (i) a first wireless communication interface for communicating over a wide area network (WAN) and (ii) a second wireless communication interface for communicating with at least one of controller devices or playback devices, the method comprising:
transmitting, via the second wireless communication interface, an indication that the playback device is available for connection;
receiving, via the second wireless communication interface, from a first controller device that is installed with an application for controlling the playback device, a first request to connect to the playback device;
based on the first request, connecting to the first controller device via the second wireless communication interface;
while connected to first controller device:
continuing to transmit, via the second wireless communication interface, the indication that the playback device is available for connection;
receiving, via the second wireless communication interface, from a second controller device that is installed with the application for controlling the playback device, a second request to connect to the playback device; and
based on the second request, connecting to the second controller device via the second wireless communication interface; and
while connected to both the first controller device and the second controller device:
continuing to transmit, via the second wireless communication interface, the indication that the playback device is available for connection;
receiving, via the second wireless communication interface, from the first controller device, an indication of media content for playback;
retrieving, via the first wireless communication interface over the WAN, the indicated media content; and
playing back the indicated media content.
